(19) United States
(12) Patent Application Publication
(10) Pub. No.: US 2022/0085951 A1
(43) Pub. Date: Mar. 17, 2022

(54) METHOD AND TRANSMISSION TERMINAL FOR RECEIVING FEEDBACK SIGNAL IN WIRELESS COMMUNICATION SYSTEM

(71) Applicant: LG ELECTRONICS INC., Seoul (KR)

(72) Inventors: Seungmin LEE, Seoul (KR); Hyukjin CHAE, Seoul (KR); Hanbyul SEO, Seoul (KR); Daesung HWANG, Seoul (KR)

(73) Assignee: LG ELECTRONICS INC., Seoul (KR)

(21) Appl. No.: 17/422,139

(22) PCT Filed: Jan. 13, 2020
(86) PCT No.: PCT/KR2020/000637

§ 371 Date: Jul. 9, 2021

(30) Foreign Application Priority Data
Jan. 11, 2019 (KR) 10-2019-0004248
Jan. 11, 2019 (KR) 10-2019-0004249
Jan. 11, 2019 (KR) 10-2019-0004250

(51) Int. Cl. H04L 5/00; B60W 60/00

(52) U.S. Cl. CPC H04L 5/0053; H04L 25/0202; B60W 60/0051; B60W 60/0053

(57) ABSTRACT

A method of receiving a feedback signal by a transmission terminal in a wireless communication system includes the transmission terminal transmitting a reference signal to a plurality of reception terminals and the transmission terminal receiving a plurality of feedback signals based on the reference signal from the plurality of reception terminals. Each of the plurality of feedback signals includes a signal, to which different phase compensation applies.

### BACKGROUND OF THE INVENTION

### Field of the Invention

The following description relates to a wireless communication system and, more particularly, to a method of receiving a feedback signal and a transmission terminal.

### DESCRIPTION OF THE RELATED ART

As more communication apparatuses require larger communication capacities, there is a need for improved mobile broadband communication compared to a conventional radio access technology. In addition, massive machine type communications (mMTC) for providing various services anytime anywhere by connecting a plurality of devices and things is also one of major issues to be considered in next-generation communication. In addition, communication system design considering services/UEs sensitive to reliability and latency is being discussed. Introduction of next-generation RAT considering Enhanced mobile Broadband Communication (eMBB), mMTC, Ultra-Reliable and Low Latency Communication (URLLC), etc. is being discussed. In this disclosure, this technology is referred to new radio (NR) for convenience. NR is an expression indicating an example of 5G radio access technology (RAT).

A new RAT system including NR uses an OFDM transmission method or a transmission method similar thereto. The new RAT system may follow OFDM parameters different from OFDM parameters of LTE. Alternatively, the new RAT system may follow numerology of existing LTE/LTE-A but may have a larger system bandwidth (e.g., 100 MHZ). Alternatively, one cell may support a plurality of numerologies. That is, user equipments (UEs) operating with different numerologies may coexist in one cell.

Vehicle-to-everything (V2X) means communication technology for exchanging information with other vehicles, pedestrians and things equipped with infrastructure through wired/wireless communication, and may include four types such as vehicle-to-vehicle (V2V), vehicle-to-infrastructure (V2I), vehicle-to-network (V2N) and vehicle-to-pedestrian (V2P). V2X communication may be provided through a PC5 interface and/or a Uu interface.

### SUMMARY OF THE INVENTION

The present disclosure proposes a method of efficiently transmitting a HARQ feedback signal when transmitting groupcast packets and broadcast packets.

The technical problems solved by the present disclosure are not limited to the above technical problems and other technical problems which are not described herein will become apparent to those skilled in the art from the following description.

A method of receiving a feedback signal by a transmission terminal in a wireless communication system includes the transmission terminal transmitting a reference signal to a plurality of reception terminals and the transmission terminal receiving a plurality of feedback signals based on the reference signal from the plurality of reception terminals. Each of the plurality of feedback signals includes a signal, to which different phase compensation applies.

A transmission terminal for receiving a feedback signal in a wireless communication system includes a transceiver and a processor. The processor transmits a reference signal to a plurality of reception terminals and receives a plurality of feedback signals based on the reference signal from the plurality of reception terminals, and each of the plurality of feedback signals includes a signal, to which different phase compensation applies.

A channel used for phase compensation of the plurality of feedback signals may be determined based on a reference antenna port

The method may further include transmitting information on the reference antenna port to the plurality of reception terminals through physical layer signaling or higher layer signaling

The information on the reference antenna port may indicate at least one of a demodulation reference signal (DMRS) port of a physical sidelink shared channel (PSSCH) or a DMRS port of a physical sidelink control channel (PSCCH).

The transmission terminal may transmit a reference signal or a sounding reference signal (SRS) used for channel state information (CSI) measurement based on the reference antenna port.

The phase compensation may be based on a channel function based on the reference signal, a sequence for the phase compensation based on the channel function may be expressed by

$${a}_{k} = \frac{λ}{H ( k )} ,$$

and the channel function H(k) may be expressed by H(k)=Aₖ exp(jBₖ), where, aₖ denotes a complex value of a sequence transmitted in a k-th tone, Aₖ denotes an amplitude of a multipath channel of a k-th frequency resource region, Bₖ denotes a value of a phase of a multipath channel of the k-th frequency resource region, and λₖ denotes a parameter for power normalization.

A sequence for phase compensation may be expressed by aₖ exp(−jX), where aₖ denotes a complex value of a sequence transmitted in a k-th tone and X denotes an average value of phase values obtained through channel estimation

The reception terminal may be configured to randomize a phase compensation value applied to transmission of the plurality of feedback signals, when channel estimation accuracy is lower than a predetermined threshold.

The feedback signal may indicate only negative acknowledge (NACK).

The transmission terminal may communicate with at least one of a mobile terminal, a network or an autonomous vehicle other than the device.

The transmission terminal may implement at least one advanced driver assistance system (ADAS) function based on a signal for controlling movement of the terminal.

The terminal may receive user input and switch a driving mode of a device from an autonomous driving mode to a manual driving mode or from a manual driving mode to an autonomous driving mode.

The transmission terminal may be autonomously driven based on external object information, and the external object information may include at least one of information on presence/absence of an object, location information of the object, information on a distance between the transmission terminal and the object or relative speed information of the transmission terminal and the object.

According to the present disclosure, it is possible to overcome destructive interference when a plurality of UEs performs HARQ feedback through shared resources.

It will be appreciated by persons skilled in the art that that the effects that can be achieved through the present disclosure are not limited to the above-described effects and other effects which are not described herein may be understood by those skilled in the art from the following detailed description.

### BRIEF DESCRIPTION OF THE DRAWINGS

The accompany drawings which are included for further understanding of the disclosure and included in this disclosure and which form part of the disclosure illustrate embodiments of the disclosure along with the detailed description that describes the principle of the disclosure.

FIG. 1 is a view showing an example of a frame structure in NR.

FIG. 2 is a view showing an example of a resource grid in NR.

FIG. 3 is a view illustrating sidelink synchronization.

FIG. 4 is a view showing a time resource unit in which a sidelink synchronization signal is transmitted.

FIG. 5 is a view showing an example of a sidelink resource pool.

FIG. 6 is a diagram illustrating scheduling schemes according to sidelink transmission modes.

FIG. 7 is a view showing selection of sidelink transmission resources.

FIG. 8 is a view showing transmission of a sidelink PSCCH.

FIGS. 9a and 9b are views showing transmission of a PSCCH in sidelink V2X.

FIG. 10 is a flowchart illustrating an embodiment of the present disclosure.

FIG. 11 is a view illustrating a distance d between a transmission terminal (UE A) and a reception terminal (UE B).

FIG. 12 is a view illustrating a time offset and propagation delay of a FFT window between a transmission terminal and a reception terminal according to an embodiment of the present disclosure.

FIG. 13 is a view illustrating a time offset and propagation delay of a FFT window between a transmission terminal and a reception terminal according to another embodiment of the present disclosure.

FIG. 14 is a flowchart illustrating an embodiment of the present disclosure.

FIG. 15 is a view illustrating a communication system, to which an embodiment of the present disclosure is applicable.

FIG. 16 is a block diagram illustrating a wireless device, to which an embodiment of the present disclosure is applicable.

FIG. 17 is a view illustrating a signal processing circuit for a transmission signal, to which an embodiment of the present disclosure is applicable.

FIG. 18 is a block diagram illustrating a wireless device, to which another embodiment of the present disclosure is applicable.

FIG. 19 is a block diagram illustrating a handheld device, to which another embodiment of the present disclosure is applicable.

FIG. 20 is a block diagram showing a vehicle or an autonomous vehicle, to which another embodiment of the present disclosure is applicable.

FIG. 21 is a view showing a vehicle, to which another embodiment of the present disclosure is applicable.

### DESCRIPTION OF THE PREFERRED EMBODIMENTS

In the disclosure, downlink (DL) refers to communication from a base station (BS) to a user equipment (UE), and uplink (UL) refers to communication from the UE to the BS. On DL, a transmitter may be a part of the BS and a receiver may be a part of the UE, whereas on UL, a transmitter may be a part of the UE and a receiver may be a part of the BS. ABS may be referred to as a first communication device, and a UE may be referred to as a second communication device in the present disclosure. The term BS may be replaced with fixed station, Node B, evolved Node B (eNB), next generation Node B (gNB), base transceiver system (BTS), access point (AP), network or 5G network node, artificial intelligence (AI) system, road side unit (RSU), robot and so on. The term UE may be replaced with terminal, mobile station (MS), user terminal (UT), mobile subscriber station (MSS), subscriber station (SS), advanced mobile station (AMS), wireless terminal (WT), device-to-device (D2D) device, vehicle, robot, AI module and so on.

The following technology may be used in various wireless access systems including code division multiple access (CDMA), frequency division multiple access (FDMA), time division multiple access (TDMA), orthogonal frequency division multiple access (OFDMA), and single carrier FDMA (SC-FDMA). CDMA may be implemented by radio technologies such as Universal Terrestrial Radio Access (UTRA) or CDMA2000. TDMA may be implemented by radio technologies such as Global System for Mobile communications (GSM)/General Packet Radio Service (GPRS)/Enhanced Data Rates for GSM Evolution (EDGE). OFDMA may be implemented by radio technologies such as IEEE 802.11 (Wi-Fi), IEEE 802.16 (WiMAX), IEEE 802-20 or E-UTRA (Evolved UTRA). UTRA is part of a Universal Mobile Telecommunications System (UMTS). 3rd Generation Partnership Project (3GPP) Long Term Evolution (LTE) is part of an Evolved UMTS (E-UMTS) using E-UTRA, and LTE-A (Advanced)/LTE-A pro is an evolved version of 3GPP LTE. New Radio or New Radio Access Technology (3GPP NR) is an evolved version of 3GPP LTE/LTE-A/LTE-A pro.

In order to clarify the description, the description is based on a 3GPP communication system (e.g., LTE-A or NR), but the technical spirit of the present disclosure is not limited thereto. LTE means technology after 3GPP TS 36.xxx Release 8. Specifically, LTE technology after 3GPP TS 36.xxx Release 10 is referred to as LTE-A and LTE technology after 3GPP TS 36.xxx Release 13 is referred to as LTE-A pro. 3GPP NR means technology after TS 38.xxx Release 15. LTE/NR may be referred to as a 3GPP system. “xxx” means a detailed standard document number. LTE/NR may be collectively referred to as a 3GPP system.

In this disclosure, a node refers to a fixed point capable of transmitting/receiving a radio signal through communication with a UE. Various types of BSs may be used as nodes regardless of the name thereof. For example, a BS, NB, eNB, pico-cell eNB (PeNB), home eNB (HeNB), relay, repeater, etc. may be a node. In addition, the node may not be a BS. For example, the node may be a radio remote head (RRH) or a radio remote unit (RRU). The RRH, the RRU, etc. generally have lower power levels than the BS. At least one antenna is installed in one node. The antenna may mean a physical antenna or may mean an antenna port, a virtual antenna or an antenna group. The node may be referred to as a point.

In the present disclosure, a cell may refer to a certain geographical area or radio resources, in which one or more nodes provide a communication service. A “cell” as a geographical area may be understood as coverage in which a service may be provided in a carrier, while a “cell” as radio resources is associated with the size of a frequency configured in the carrier, that is, a bandwidth (BW). Because a range in which a node may transmit a valid signal, that is, DL coverage and a range in which the node may receive a valid signal from a UE, that is, UL coverage depend on a carrier carrying the signals, and thus the coverage of the node is associated with the “cell” coverage of radio resources used by the node. Accordingly, the term “cell” may mean the service overage of a node, radio resources, or a range in which a signal reaches with a valid strength in the radio resources, under circumstances.

In the present disclosure, communication with a specific cell may amount to communication with a BS or node that provides a communication service to the specific cell. Further, a DL/UL signal of a specific cell means a DL/UL signal from/to a BS or node that provides a communication service to the specific cell. Particularly, a cell that provides a UL/DL communication service to a UE is called a serving cell for the UE. Further, the channel state/quality of a specific cell refers to the channel state/quality of a channel or a communication link established between a UE and a BS or node that provides a communication service to the specific cell.

A “cell” associated with radio resources may be defined as a combination of DL resources and UL resources, that is, a combination of a DL component carrier (CC) and a UL CC. A cell may be configured with DL resources alone or both DL resources and UL resources in combination. When carrier aggregation (CA) is supported, linkage between the carrier frequency of DL resources (or a DL CC) and the carrier frequency of UL resources (or a UL CC) may be indicated by system information transmitted in a corresponding cell. A carrier frequency may be identical to or different from the center frequency of each cell or CC. Hereinbelow, a cell operating in a primary frequency is referred to as a primary cell (Pcell) or PCC, and a cell operating in a secondary frequency (or SCC) is referred to as a secondary cell (Scell) or SCC. The Scell may be configured after a UE and a BS perform a radio resource control (RRC) connection establishment procedure and thus an RRC connection is established between the UE and the BS, that is, the UE is RRC_CONNECTED. The RRC connection may mean a path in which the RRC of the UE may exchange RRC messages with the RRC of the BS. The Scell may be configured to provide additional radio resources to the UE. The Scell and the Pcell may form a set of serving cells for the UE according to the capabilities of the UE. Only one serving cell configured with a Pcell exists for an RRC_CONNECTED UE which is not configured with CA or does not support CA.

A cell supports a unique radio access technology (RAT). For example, LTE RAT-based transmission/reception is performed in an LTE cell, and 5G RAT-based transmission/reception is performed in a 5G cell.

CA aggregates a plurality of carriers each having a smaller system BW than a target BW to support broadband. CA differs from OFDMA in that DL or UL communication is conducted in a plurality of carrier frequencies each forming a system BW (or channel BW) in the former, and DL or UL communication is conducted by loading a basic frequency band divided into a plurality of orthogonal subcarriers in one carrier frequency in the latter. In OFDMA or orthogonal frequency division multiplexing (OFDM), for example, one frequency band having a certain system BW is divided into a plurality of subcarriers with a predetermined subcarrier spacing, information/data is mapped to the plurality of subcarriers, and the frequency band in which the information/data has been mapped is transmitted in a carrier frequency of the frequency band through frequency upconversion. In wireless CA, frequency bands each having a system BW and a carrier frequency may be used simultaneously for communication, and each frequency band used in CA may be divided into a plurality of subcarriers with a predetermined subcarrier spacing.

The 3GPP communication standards define DL physical channels corresponding to resource elements (REs) conveying information originated from upper layers of the physical layer (e.g., the medium access control (MAC) layer, the radio link control (RLC) layer, the packet data convergence protocol (PDCP) layer, the radio resource control (RRC) layer, the service data adaptation protocol (SDAP) layer, and the non-access stratum (NAS) layer), and DL physical signals corresponding to REs which are used in the physical layer but do not deliver information originated from the upper layers. For example, physical downlink shared channel (PDSCH), physical broadcast channel (PBCH), physical multicast channel (PMCH), physical control format indicator channel (PCFICH), and physical downlink control channel (PDCCH) are defined as DL physical channels, and a reference signal (RS) and a synchronization signal are defined as DL physical signals. An RS, also called a pilot is a signal in a predefined special waveform known to both a BS and a UE. For example, cell specific RS (CRS), UE-specific RS (UE-RS), positioning RS (PRS), channel state information RS (CSI-RS), and demodulation RS (DMRS) are defined as DL RSs. The 3GPP communication standards also define UL physical channels corresponding to REs conveying information originated from upper layers, and UL physical signals corresponding to REs which are used in the physical layer but do not carry information originated from the upper layers. For example, physical uplink shared channel (PUSCH), physical uplink control channel (PUCCH), and physical random access channel (PRACH) are defined as UL physical channels, and DMRS for a UL control/data signal and sounding reference signal (SRS) used for UL channel measurement are defined.

In this disclosure, a physical downlink control channel (PDCCH) and a physical downlink shared channel (PDSCH) may mean a set of time-frequency resources or a set of resource elements carrying downlink control information (DCI) and downlink data of a physical layer. In addition, a physical uplink control channel, a physical uplink shared channel (PUSCH) and a physical random access channel means a set of time-frequency resources or a set of resource elements carrying uplink control information (UCI), uplink data and random access signals of a physical layer. Hereinafter, a UE transmitting an uplink physical channel (e.g., PUCCH, PUSCH or PRACH) may mean that DCI, uplink data or random access signals are transmitted over or through the uplink physical channel. A BS receiving an uplink physical channel may mean that DCI, uplink data or random access signals are received over or through the uplink physical channel. A BS transmitting a downlink physical channel (e.g., PDCCH or PDSCH) is used as the same meaning as transmission of DCI or uplink data over or through the downlink physical channel. A UE receiving a downlink physical channel may mean that DCI or uplink data is received over or through the downlink physical channel.

In this disclosure, a transport block is a payload for a physical layer. For example, data given to a physical layer from a higher layer or a medium access control (MAC) layer is basically referred to as a transport block.

In the present disclosure, HARQ is a kind of error control technique. A HARQ-ACK transmitted on DL is used for error control of UL data, and a HARQ-ACK transmitted on UL is used for error control of DL data. A transmitter performing an HARQ operation awaits reception of an ACK after transmitting data (e.g., a TB or a codeword). A receiver performing an HARQ operation transmits an ACK only when data has been successfully received, and a negative ACK (NACK) when the received data has an error. Upon receipt of the ACK, the transmitter may transmit (new) data, and upon receipt of the NACK, the transmitter may retransmit the data. Time delay occurs until ACK/NACK is received from a UE and retransmission data is transmitted after the BS transmits scheduling information and data according to the scheduling information. Such time delay occurs due to channel propagation delay or a time required to decode/encode data. Accordingly, when new data is transmitted after a HARQ process which is currently in progress is finished, a gap occurs in data transmission due to time delay. Accordingly, a plurality of independent HARQ processes is used to prevent a gap from occurring in data transmission during a time delay period. For example, when there are seven transmission occasions between initial transmission and retransmission, a communication device may perform data transmission without a gap by performing seven independent HARQ processes. When a plurality of parallel HARQ processes is used, UL/DL transmission may be continuously performed while waiting for HARQ feedback for previous UL/DL transmission.

In the present disclosure, CSI generically refers to information representing the quality of a radio channel (or link) established between a UE and an antenna port. The CSI may include at least one of a channel quality indicator (CQI), a precoding matrix indicator (PMI), a CSI-RS resource indicator (CRI), a synchronization signal block resource indicator (SSBRI), a layer indicator (LI), a rank indicator (RI), or a reference signal received power (RSRP).

In the present disclosure, frequency division multiplexing (FDM) is transmission/reception of signals/channels/users in different frequency resources, and time division multiplexing (TDM) is transmission/reception of signals/channels/users in different time resources.

In the present disclosure, frequency division duplex (FDD) is a communication scheme in which UL communication is performed in a UL carrier, and DL communication is performed in a DL carrier linked to the UL carrier, whereas time division duplex (TDD) is a communication scheme in which UL communication and DL communication are performed in time division in the same carrier.

For background technologies, terms, abbreviations used in this disclosure, refer to matters described in the standard documents published prior to the present disclosure. For example, documents corresponding to 3GPP TS 36, 24 and 38 series (http://www.3gpp.org/specifications/specification-numbering) may be referred to.

Frame Structure

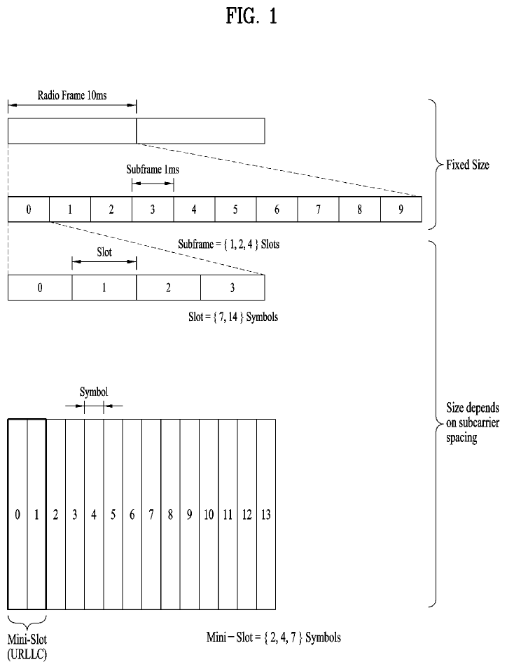

FIG. 1 is a view showing an example of a frame structure in NR.

The NR system may support a plurality of numerologies. Here, the numerology may be defined by a subcarrier spacing and cyclic prefix (CP) overhead. At this time, a plurality of subcarrier spacings may be derived by scaling a basic subcarrier spacing with an integer N (or μ). In addition, even if it is assumed that a very low subcarrier spacing is not used in a very high carrier frequency, a used numerology may be selected independently of the frequency band of a cell. In addition, in the NR system, various frame structures according to the plurality of numerologies may be supported.

Hereinafter, an orthogonal frequency division multiplexing (OFDM) numerology and a frame structure which may be considered in the NR system will be described. The plurality of OFDM numerologies supported in the NR system may be defined as shown in Table 1. μ and cyclic prefix for a bandwidth part are obtained from RRC parameters provided by the BS.

TABLE 1

| μ | Δf = 2^{μ}*15 [kHz] | Cyclic prefix (CP) |
|---|---|---|
| 0 | 15 | Normal |
| 1 | 30 | Normal |
| 2 | 60 | Normal, |
| | | Extended |
| 3 | 120 | Normal |
| 4 | 240 | Normal |

NR supports the plurality of numerologies (e.g., subcarrier spacings) supporting various 5G services. For example, when the subcarrier spacing is 15 kHz, a wide area in traditional cellular bands is supported. When the subcarrier spacing is 30 kHz/60 kHz, dense-urban, lower latency and wider carrier bandwidth are supported. When the subcarrier spacing is equal to or higher than 60 kHz, bandwidth greater than 24.25 GHz is supported to overcome phase noise.

Resource Grid

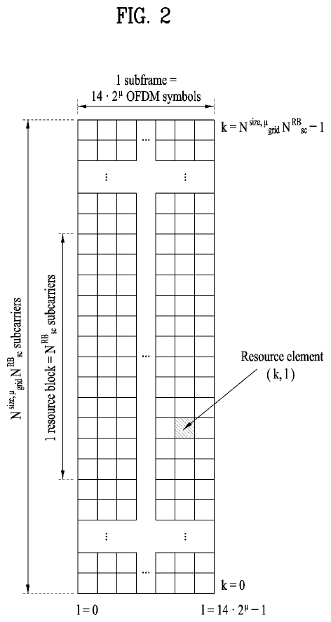

FIG. 2 is a view showing an example of a resource grid in NR.

Referring to FIG. 2, for each subcarrier spacing setting and carrier, a resource grid of N^{size,μ}_{grid}*N^{RB}_{sc} subcarriers and 14·2^{μ} OFDM symbols is defined. Here, N^{size,μ}_{grid} is indicated by RRC signaling from the BS. N^{size,μ}_{grid} may vary according to uplink and downlink as well as the subcarrier spacing setting μ. There is one resource grid for subcarrier spacing setting μ, antenna port p and a transmission direction (uplink or downlink). Each element of the resource grid for subcarrier spacing setting μ and antenna port p is referred to as a resource element and is uniquely identified by an index pair (k,l). Here, k denotes an index in a frequency domain and l denotes a symbol location in the frequency domain relative to a reference point. A resource element (k,l) for subcarrier spacing setting p and antenna port p correspond to physical resource and complex value a^{(p,μ)}_{k,l}. A resource block (RB) is defined by N^{RB}_{sc}=12 consecutive subcarriers in the frequency domain.

Considering that the UE cannot support a wide bandwidth to be supported in the NR system at once, the UE may be configured to operate in a part of the frequency bandwidth of the cell (hereinafter referred to as a bandwidth part (BWP)).

Bandwidth Part (BWP)

In the NR system, up to 400 MHz may be supported per carrier. If a UE operating in such a wideband carrier operates in a state in which a radio frequency (RF) module for the entire carrier is always turned on, UE battery consumption may increase. Alternatively, considering various use cases (e.g., eMBB, URLLC, mMTC, V2X, etc.) in which the UE operates in one wideband carrier, different numerologies (e.g., subcarrier spacings) may be supported for each frequency band in the carrier. Alternatively, capabilities for maximum bandwidth may vary according to UE. In consideration of this, the BS may instruct the UE to operate in a partial bandwidth rather than the entire bandwidth of the wideband carrier, and the partial bandwidth may be referred to as a bandwidth part (BWP). In the frequency domain, the BWP is a subset of contiguous common resource blocks defined for numerology μi in the bandwidth part i on the carrier, and one numerology (e.g., a subcarrier spacing, a CP length, a slot/mini-slot duration) may be set.

Meanwhile, the BS may set one or more BWPs in one carrier set for the UE. Alternatively, when UEs are concentrated on a specific BWP, some UEs may move to another BWP for load balancing. Alternatively, in consideration of frequency domain inter-cell interference cancellation between neighbor cells, some spectrums of the entire bandwidth may be excluded and both BWPs of a cell may be set in the same slot. That is, the BS may set at least one DL/UL BWP for a UE associated with the wideband carrier, and at least one of DL/UL BWP(s) set at a specific time may be activated (by L1 signaling which is a physical layer control signal, a MAC control element (CE) which is a MAC layer control signal, or RRC signaling), switching to another set DL/UL BWP may be indicated (by L1 signaling, MAC CE, or RRC signaling), or a timer value may be set to switch a DL/UL BWP determined by the UE when the timer expires. The activated DL/UL BWP is particularly referred to an active DL/UL BWP. When the UE is in an initial access process or before RRC connection of the UE is established, the UE may not receive a configuration for the DL/UL BWP. In this situation DL/UL BWP assumed by the UE may be referred to as an initial active DL/UL BWP.

Synchronization Acquisition of Sidelink UE

In a time division multiple access (TDMA) and frequency division multiples access (FDMA) system, accurate time and frequency synchronization is essential. When time and frequency synchronization is not accurate, inter-symbol interference (ISI) and intercarrier interference (ICI) are caused, thereby deteriorating system performance. The same is true in V2X. In V2X, for time/frequency synchronization, a sidelink synchronization signal (SLSS) may be used in a physical layer and master information block-sidelink-V2X (MIB-SL) may be used in a radio link control (RLC) layer.

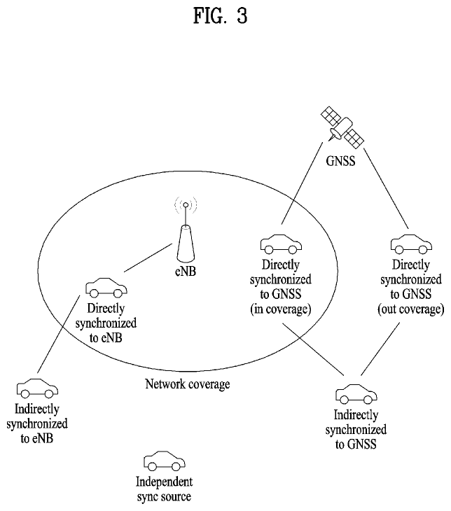

FIG. 3 is a view showing an example of a source of synchronization or a criterion of synchronization in V2X.

As shown in FIG. 3, in V2X, a UE may be directly synchronized to a global navigation satellite systems (GNSS) or may be indirectly synchronized to the GNSS through a UE directly synchronized to the GNSS (inside network coverage or outside network coverage). When the GNSS is set as a synchronization source, the UE may calculate a direct frame number (DFN) and a subframe number using coordinated universal time (UTC) and a (pre)determined DFN offset.

Alternatively, the UE may be directly synchronized to an eNB or may be synchronized to another UE time/frequency-synchronized to the eNB. For example, when the UE is located inside network coverage, the UE may receive synchronization information provided by the eNB and may be directly synchronized to the eNB. Thereafter, synchronization information may be provided to another adjacent UE. When eNB timing is set as a criterion of synchronization, for synchronization and downlink measurement, the UE may follow a cell associated with a corresponding frequency (when being inside cell coverage at the frequency) and a primary cell or a serving cell (when being outside cell coverage at the frequency).

The eNB (serving cell) may provide synchronization setting for a carrier used for V2X sidelink communication. In this case, the UE may follow synchronization setting received from the eNB. If no cell is detected in the carrier used for V2X sidelink communication and synchronization setting is not received from the serving cell, the UE may follow preset synchronization setting.

Alternatively, the UE may be synchronized to another UE which does not directly or indirectly acquire synchronization information from the eNB or the GNSS. The source and preference of synchronization may be pre-set for the UE or may be set through a control message provided by the eNB.

Now, a synchronization signal (SLSS) and synchronization information will be described.

The SLSS is a sidelink-specific sequence and may include a primary sidelink synchronization signal (PSSS) and a secondary sidelink synchronization signal (SSSS).

Each SLSS may have a physical layer sidelink synchronization Identity (ID) and the value thereof may be any one of 0 to 335. The synchronization source may be identified according to which of the above-described values is used. For example, 0, 168 and 169 may mean the GNSS, 1 to 167 may mean the eNB, and 170 to 335 may mean the outside of coverage. Alternatively, among the values of the physical layer sidelink synchronization ID, 0 to 167 may be values used by a network and 168 to 335 may be values used outside network coverage.

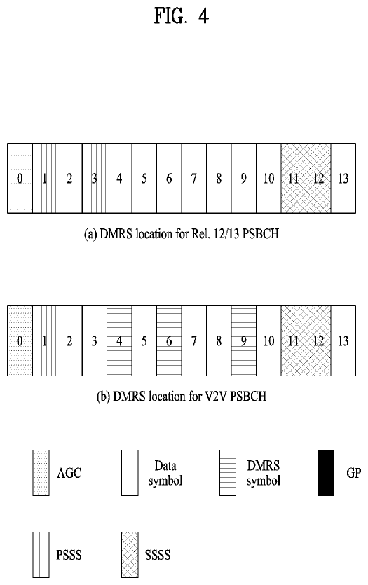

FIG. 4 is a view showing a time resource unit in which a sidelink synchronization signal is transmitted. Here, the time resource unit may mean a subframe in LTE/LTE-A and a slot in 5G, details of which are disclosed in 3GPP TS 36 series or 38 series. A physical sidelink broadcast channel (PSBCH) may be a channel in which basic (system) information, which should be first known to the UE before sidelink signal transmission/reception (e.g., information related to the SLSS, a duplex mode (DM), a TDD UL/DL configuration, resource pool related information, the type of an application related to the SLSS, a subframe offset, broadcast information, etc.) is transmitted (broadcast). The PSBCH may be transmitted in the same time resource unit as the SLSS or a subsequent time resource unit. The DMRS may be used for demodulation of the PSBCH.

Sidelink Transmission Mode

In sidelink, there are transmission modes 1, 2, 3 and 4.

In transmission mode 1/3, an eNB performs resource scheduling through a PDCCH (more specifically, DCI) with respect to a UE 1, and the UE 1 performs D2D/V2X communication with a UE 2 according to the resource scheduling. The UE 1 may transmit sidelink control information (SCI) to the UE 2 through a physical sidelink control channel (PSCCH) and then transmit data based on the SCI through a physical sidelink shared channel (PSSCH). Transmission mode 1 is applicable to D2D and transmission mode 3 is applicable to V2X.

Transmission mode 2/4 may be a mode in which a UE performs scheduling by itself. More specifically, transmission mode 2 is applicable to D2D and a UE may select resources by itself in a set resource pool to perform D2D operation. Transmission mode 4 is applicable to V2X and a UE may select resources by itself within a selection window through a sensing process and then perform V2X operation. The UE 1 may transmit SCI to the UE 2 through a PSCCH and then transmit data based on the SCI through a PSSCH. Hereinafter, the transmission mode may be briefly referred to as a mode.

Control information transmitted from the eNB to the UE through the PDCCH may be referred to as downlink control information (DCI) and control information transmitted from the UE to another UE through a PSCCH may be referred to as SCI. The SCI may deliver sidelink scheduling information. The SCI may have various formats, for example, SCI format 0 and SCI format 1.

SCI format 0 may be used for scheduling of the PSSCH. SCI format 0 may include a frequency hopping flag (1 bit), a resource block allocation and hopping resource allocation field (the number of bits may vary depending on the number of resource blocks of sidelink), a time resource pattern (7 bits), modulation and coding scheme (MCS) (5 bits), time advance indication (11 bits), a group destination ID (8 bits), etc.

SCI format may be used for scheduling of the PSSCH. SCI format 1 includes priority (3 bits), resource reservation (4 bits), frequency resource locations of initial transmission and retransmission (the number of bits may vary according to the number of subchannels of sidelink), a time gap between initial transmission and retransmission (4 bits), MCS (5 bits), a retransmission index (1 bit), reserved information bit, etc. Hereinafter, the reserved information bit may be briefly referred to as a reserved bit. The reserved bit may be added until the bit size of SCI format 1 becomes 32 bits.

SCI format 0 may be used in transmission modes 1 and 2 and SCI format 1 may be used in transmission modes 3 and 4.

Sidelink Resource Pool

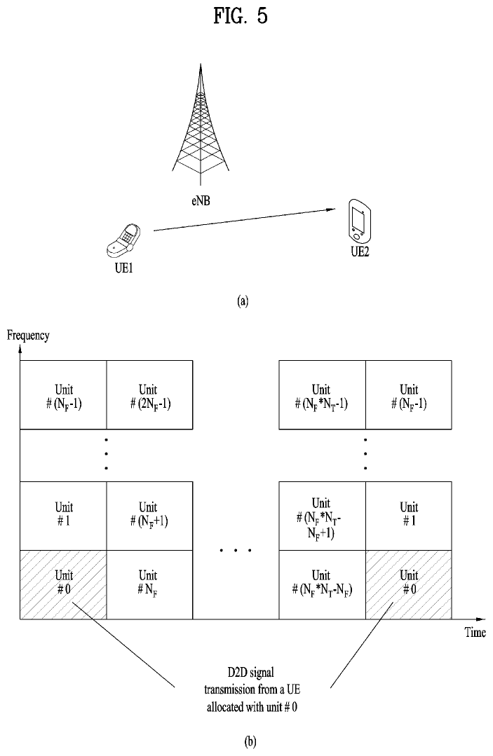

FIG. 5 shows an example of a first UE (UE1), a second UE (UE2) and a resource pool used by UE1 and UE2 performing sidelink communication.

In FIG. 5(a), a UE corresponds to a terminal or such a network device as an eNB transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located at the inside of coverage of an eNB, the eNB may inform UE1 of the resource pool. If UE1 is located at the outside of coverage of the eNB, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 5(b), the entire frequency resources are divided into the NF number of resource units and the entire time resources are divided into the NT number of resource units. In particular, it is able to define NF*NT number of resource units in total. In particular, a resource pool may be repeated with a period of NT time resource units. Specifically, as shown in FIG. 5, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Although contents of sidelink signal are identical to each other, it may use a different resource pool according to a transmission/reception attribute of the sidelink signal. For example, in case of the same sidelink data channel or the same discovery message, the sidelink data channel or the discovery signal may be classified into a different resource pool according to a transmission timing determination scheme (e.g., whether a sidelink signal is transmitted at the time of receiving a synchronization reference signal or the timing to which a prescribed timing advance is added) of a sidelink signal, a resource allocation scheme (e.g., whether a transmission resource of an individual signal is designated by an eNB or an individual transmitting UE selects an individual signal transmission resource from a pool), a signal format (e.g., number of symbols occupied by a sidelink signal in a time resource unit, number of time resource units used for transmitting a sidelink signal), signal strength from an eNB, strength of transmit power of a sidelink UE, and the like. For clarity, a method for an eNB to directly designate a transmission resource of a sidelink transmitting UE is referred to as a mode 1 (mode 3 in case of V2X). If a transmission resource region is configured in advance or an eNB designates the transmission resource region and a UE directly selects a transmission resource from the transmission resource region, it is referred to as a mode 2 (mode 4 in case of V2X). In case of performing sidelink discovery, if an eNB directly indicates a resource, it is referred to as a type 2. If a UE directly selects a transmission resource from a predetermined resource region or a resource region indicated by the eNB, it is referred to as type 1.

In V2X, sidelink transmission mode 3 based on centralized scheduling and sidelink transmission mode 4 based on distributed scheduling are available.

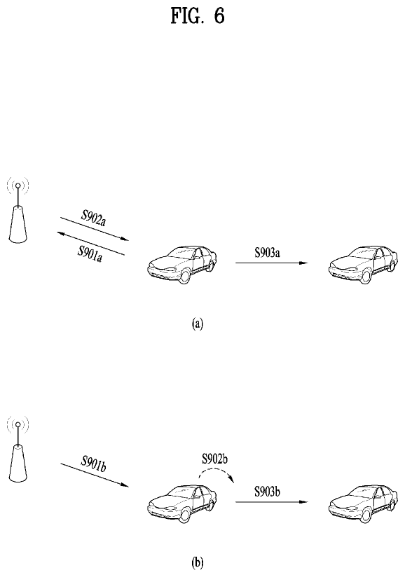

FIG. 6 illustrates scheduling schemes according to these two transmission modes. Referring to FIG. 6, in transmission mode 3 based on centralized scheduling, when a vehicle requests sidelink resources to an eNB (S901a), the eNB allocates the resources (S902a), and the vehicle transmits a signal in the resources to another vehicle (S903a). In the centralized transmission scheme, resources of another carrier may be also scheduled. In distributed scheduling corresponding to transmission mode 4 illustrated in FIG. 6(b), a vehicle selects transmission resources (S902b), while sensing resources preconfigured by the eNB, that is, a resource pool (S901b), and then transmits a signal in the selected resources to another vehicle (S903b).

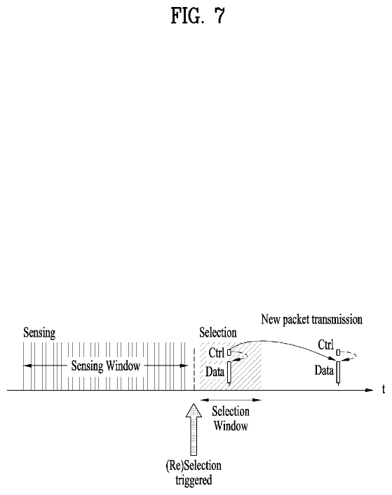

At this time, as shown in FIG. 7, in selection of transmission resources, a method of reserving transmission resources of a next packet is used. In V2X, transmission is performed twice for each MAC PDU and resources for retransmission are reserved at a certain time gap when resources for initial transmission are selected. A UE may grasp transmission resources reserved by other UEs or resources used by other UEs through sensing in a sensing window and randomly select resources from resources with little interference among the remaining resources after excluding the used resources from the selection window.

For example, the UE may decode a PSCCH including information on the period of reserved resources in the sensing window and measure a PSCCH RSRP in the resources periodically determined based on the PSCCH. Resources in which the PSSCH RSRP value exceeds a threshold may be excluded from the selection window. Thereafter, sidelink resources may be randomly selected from the remaining resources in the selection window.

Alternatively, received signal strength indication (RSSI) of periodic resources may be measured in the sensing window to grasp resources with little interference corresponding to the bottom 20%. In addition, sidelink resources may be randomly selected from the resources included in the selection window among the periodic windows. For example, when decoding of the PSCCH fails, such a method may be used.

For a detailed description thereof, refer to Section 14 of 3GPP TS 36.213 V14.6.0 document, which is incorporated herein as the related art of the present disclosure.

Transmission/Reception of PSCCH

Sidelink transmission mode 1 UE may transmit a PSCCH (or sidelink control signal or sidelink control information (SCI)) through resources configured by an eNB. Sidelink transmission mode 2 UE may receive resources which are configured by the eNB to be used for sidelink transmission. In addition, time/frequency resources may be selected from the configured resources to transmit a PSCCH.

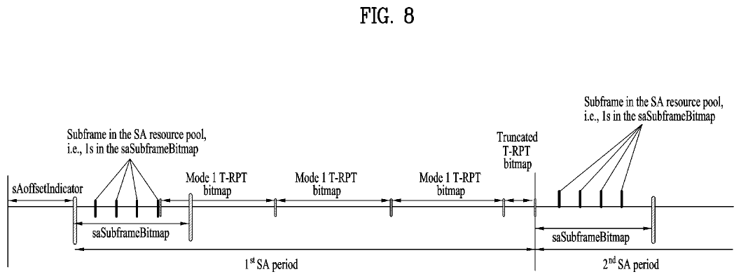

In sidelink transmission mode 1 or 2, a PSCCH period may be defined as shown in FIG. 8.

Referring to FIG. 8, a first PSCCH (or SA) period may start in a time resource unit separated from a specific system frame by a predetermined offset indicated by higher layer signaling. Each PSCCH period may include a PSCCH resource pool and a time resource unit pool for sidelink data transmission. The PSCCH resource pool may include a last time resource unit among time resource units indicated as transmission of a PSCCH in a time resource unit bitmap from a first time resource unit of a PSCCH period. In a resource pool for sidelink data transmission, in the case of mode 1, a time resource unit used for actual data transmission may be determined by applying time-resource pattern for transmission (T-RPT) or time-resource pattern (TRP). As shown in the figure, if the number of time resource units included in the PSCCH period excluding the PSCCH resource pool is greater than the number of T-RPT bits, T-RPT is repeatedly applicable and last applied T-RPT may be truncated by the number of remaining resource units and applied. A transmission UE performs transmission at a location where a T-RPT bitmap is 1 in the indicated T-RPT, and one MAC PDU is transmitted four times.

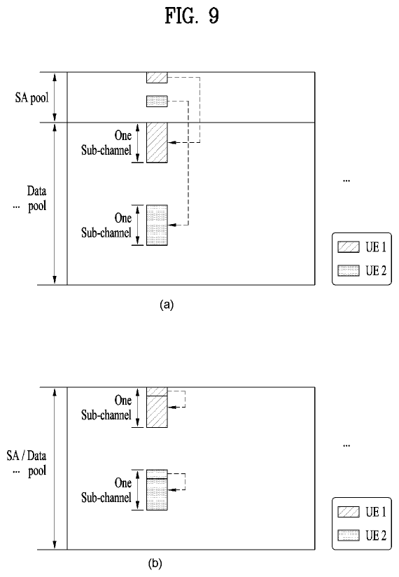

In the case of V2X, that is, sidelink transmission mode 3 or 4, unlike sidelink, a PSCCH and data (PSSCH) are transmitted using a FDM scheme. In V2X, because of the characteristics of vehicle communication, it is important to reduce delay. To this end, the PSCCH and data are FDM-transmitted on different frequency resources on the same time resources. FIG. 9 shows an example of such a transmission scheme. Any one of a scheme in which the PSCCH and the data are not directly contiguous as shown in FIG. 9(a) or a scheme in which the PSCCH and the data are directly contiguous as shown in FIG. 9(b) may be used. The basic unit of such transmission is a subchannel. The subchannel is a resource unit having a size of one or more RBs on a frequency axis on a predetermined time resource (e.g., a time resource unit). The number of RBs included in the subchannel, that is, the size of the subchannel and the start location on the frequency axis of the subchannel are indicated through higher layer signaling.

Meanwhile, in vehicle-to-vehicle communication, a periodic message type cooperative awareness message (CAM), an event triggered message type decentralized environmental notification message (DENM), etc. may be transmitted. The CAM may include vehicle dynamic state information such as a direction and a speed, vehicle static data such as dimensions and basic vehicle information such as external lighting states and a route history. The size of the CAM may be 50 to 300 bytes. The Cam may broadcast and latency needs to be less than 100 ms. The DENM may be generated in unexpected situations such as vehicle breakdown or accidents. The size of the DENM may be less than 3000 bytes, and all vehicles in a transmission range may receive the message. At this time, the DENM may have higher priority than the CAM. The message having higher priority may mean that the message having higher priority is preferentially transmitted when two messages need to be simultaneously from the viewpoint of one UE or mean that a message having higher priority among several messages is preferentially transmitted in terms of time. From the viewpoint of several UEs, a message having higher priority has less interference than a message having lower priority, thereby decreasing a reception error probability. Even in the CAM, the size of the message when security overhead is included may be larger than that of the message when security overhead is not included.

Sidelink Congestion Control

A sidelink communication wireless environment may be easily congested according to the density of vehicles, an increase in the amount of transmitted information, etc. At this time, various methods are applicable in order to reduce congestion. As an example, there is distributive congestion control.

In distributive congestion control, a UE grasps a congestion situation of a network and performs transmission control. At this time, congestion control considering priority of traffic (e.g., packets) is necessary.

Specifically, each UE measures a channel busy ratio (CBR) and determines a maximum value CRlimitk of a channel utilization CRk for each traffic priority (e.g., k) according to the CBR. For example, the UE may derive the maximum value CRlimitk of the channel utilization for each traffic priority based on the CBR measurement value and a predetermined table. In the case of traffic having relatively high priority, a larger maximum value of the channel utilization may be derived.

Thereafter, the UE may perform congestion control by limiting the total sum of the channel utilization of traffics having priority k lower than i to a certain value or less. According to this method, the channel utilization of traffics having relatively lower priorities is more strictly limited.

Besides, the UE may use size adjustment of transmit power, packet drop, determination of retransmission, transmission RB size adjustment (MCS adjustment), etc.

5G Use Cases

Three main requirement areas of 5G include (1) an enhanced mobile broadband (eMBB) area, (2) a massive machine type communication (mMTC) area and (3) an ultra-reliable and low latency communications (URLLC) area.

Some use cases may require a plurality of areas for optimization and the other use cases may focus upon only one key performance indicator (KPI). 5G supports various use cases using a flexible and reliable method.

eMBB is much superior to basic mobile Internet access and covers media and entertainment applications in rich interactive work, cloud or augmented reality. Data is one of key powers of 5G and, in the 5G era, a dedicated voice service cannot be seen for the first time. In 5G, voice is expected to be processed as an application program simply using data connection provided by a communication system. Main causes for increased traffic volume is an increase in the number of applications requiring a high data transfer rate and an increase in the size of content. Streaming services (audio and video), interactive videos and mobile Internet connections will be more widely used as more devices are connected to the Internet. Such many application programs require always-on connectivity in order to push real-time information and notification to users. Cloud storage and applications are rapidly increasing in mobile communication platforms, which are applicable to both work and entertainment. In addition, cloud storage is a special use case of leading growth of an uplink data transfer rate. 5G is also used for remote work in the cloud, and requires much lower end-to-end latency to maintain a good user experience when tactile interfaces are used. Entertainment, for example, cloud gaming and video streaming, is another key element for increasing the demand for mobile broadband capabilities. Entertainment is essential on smartphones and tablets at some places including a high mobility environment, such as trains, cars and airplanes. Another use case is augmented reality and information retrieval for entertainment. Herein, augmented reality requires very low latency and an instantaneous amount of data.

In addition, one of the most expected 5G use cases relates to a function capable of smoothly connecting embedded sensors in all fields, that is, mMTC. The number of potential IoT devices are expected to reach 20.4 billion by 2020. Industrial IoT is one of areas where 5G plays major roles in enabling smart cities, asset tracking, smart utilities, agriculture and security infrastructure.

URLLC includes new services which will change the industry through ultra reliability/available low latency links, such as remote control of important infrastructure and self-driving vehicles. The level of reliability and latency is essential for smart grid control, industrial automation, robotics and drone control and adjustment.

Next, a plurality of use cases related to 5G will be described in greater detail.

5G provides a stream rated from hundreds of megabits per second to gigabits per second and may complement fiber-to-the home (FTTH) and cable-based broadband (or DOCSIS). This high speed is required for transmission to TVs with resolution of 4K or higher (6K, 8K and higher) as well as virtual reality and augmented reality. Virtual reality (VR) and augmented reality (AR) applications include immersive sports events. Certain application programs may require special network settings. For example, in the case of VR games, game companies may need to integrate core servers with edge network servers of network operators in order to minimize latency.

Automobile is expected to be new important power in 5G along with many use cases for mobile communication of vehicles. For example, entertainment for passengers requires simultaneous high capacity and high mobile broadband. This is because future users will continue to expect high-quality connection regardless of the positions and speeds thereof. Another use case of the automotive field is an augmented reality dashboard. This identifies an object in the dark on top of what a driver sees through a windshield and displays the distance and movement of the object on information given to the driver. In the future, a wireless module will enable communication between vehicles, exchange of information between a vehicle and supporting infrastructure and exchange of information between a vehicle and other connected devices (e.g., devices carried by pedestrians). A safety system may lower the risk of accidents by guiding alternative courses of action to enable safer driving of the driver. A next step will be remote control or a self-driven vehicle. This requires very reliable and very fast communication between different self-driven vehicles and between a vehicle and infrastructure. In the future, a self-driven vehicle will perform all driving activities and a driver will focus only on traffic which cannot be identified by the vehicle itself. Technical requirements of the self-driven vehicle require ultra-low latency and ultrahigh-speed reliability to increase traffic safety to a level which cannot be achieved by human.

Smart cities referred to as smart society and smart home will be embedded with a high-density wireless sensor networks. Distributive networks of intelligent sensors will identify conditions for cost and energy-efficient maintenance of cities and home. Similar settings may be done for each home. Temperature sensors, window and heater controllers, burglar alarms and appliances are all wirelessly connected. Many of such sensors typically have low data transfer rates, low power and low cost. However, for example, real-time HD video may be required for a specific type of devices for surveillance.

Consumption and distribution of energy including heat or gas is highly decentralized and thus automated control of distributive sensor networks is required. In smart grid, such sensors are interconnected using digital information and communication technologies to collect information and act accordingly. This information may include behaviors of suppliers and consumers, allowing smart grid to improve efficiency, economics, sustainability of production and distribution of fuels such as electricity in an automated manner. Smart grid may be regarded as another low-latency sensor network.

Heath sector has many application programs which may receive benefit of mobile communication. A communication system may support a remote medical service for providing clinical care far away. This may held in reducing barriers to distance and improve access to medical services which cannot be consistently available in remote rural areas. This is also used to save lives in critical medical treatment and emergencies. A wireless sensor network based on mobile communication may provide sensors and remote monitoring of parameters such as heart rate and blood pressure.

Wireless and mobile communication is becoming increasingly important in the industrial application fields. Wiring has high installation and maintenance costs. Accordingly, the possibility of replacing cables with reconfigurable wireless links is an attractive opportunity in many industries. However, achieving this requires wireless links which operate with latency, reliability and capacity similar to that of the cables, and simplified management. Low latency and very low error probability are new requirements for 5G connection.

Logistics and freight tracking are important use cases of mobile communication that enable tracking of package and inventory anywhere using a location-based information system. The use cases of logistics and freight tracking typically require low data rate but require a wide range and reliable location information.

Fading

Fading refers to decrease in charges occurring within a short time and occurs by various factors. Scattering of a path of radio waves into multiple paths due to reflection and scattering b of radio waves is referred to as multi-path fading, and delay spread occurs due to multiple paths, causing signal distortion. Attenuation of radio waves (delay spread) due to movement of a mobile station is called “Doppler effect”, which has an effect such as shift in a center frequency of radio waves due to movement of the mobile station, thereby causing a frequency shift and scattering phenomenon.

Shadow fading will now be described. In a process of transmitting radio waves through various paths, shadow areas of the radio waves occurs due to buildings or tunnels. By a model for attenuating the radio waves by trees or buildings in an actual environment, a sudden change in signal strength occurs. Path loss significantly varies according to an actual surrounding environment during transmission and reception. Correction is possible by a (multiple reflections and/or scatterings) path loss model (e.g., two-ray model). A signal which is not received at a bad location or a reception of signal with a small strength is referred to as shadow fading.

Frequency selective fading or selective fading refers to the case where coherent bandwidth is narrower than a transmission signal frequency band, which is a phenomenon appearing in association with a multi-path-channel response and occurs when multi-path delay spread is larger than a transmission symbol rate. A wirelessly transmitted signal experiences various fading environments (attenuation difference or phase difference) on a frequency while passing through a multi-path channel. As a result, if fading is measured in a certain wireless communication link, the case where a specific reception frequency causes greater attenuation than other reception frequency may be found. A fading channel may cause severe inter symbol interference (ISI) in the case of code division multiple access (CDMA) communication.

Frequency selective fading is used in a frequency-selective user scheduling scheme or a frequency diversity scheme in an orthogonal frequency division multiple access (OFDMA) system to improve overall system gain.

Time selective fading means that a fading size varies according to time, and is generated due to Doppler diffusion. It is classified into fast fading and slow fading according to how quickly a transmitted signal is changed according to a change degree of a channel.

When a mobile body (e.g., a mobile station) moves quickly, a received signal is condensed to increase bandwidth. Accordingly, a coherence time becomes smaller than a pulse duration. That is, when frequency bandwidth increases, the coherence time decreases. The coherence time becomes less than a minimum pulse duration, causing distortion. This is referred to as fast fading. In general, signal distortion increases when Doppler diffusion increases compared to the transmission frequency. In practical cases, fast fading occurs only in the case of low-speed data transmission. Conversely, the case where the coherence time is larger, that is, the case where it is safe against distortion, is referred to as slow fading.

### EMBODIMENT

The present disclosure proposes a method of transmitting a feedback signal from a reception terminal to a transmission UE in a wireless communication system. In addition, in the present disclosure, a high-resolution distance estimation scheme based on phase difference of arrival (PDoA) in a frequency selective fading channel is proposed. In the present disclosure, a transmission terminal may be referred to as Tx UE or UE A, and a reception terminal may be referred to as Rx UE or UE B.

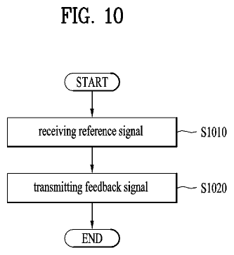

FIG. 10 is a flowchart illustrating operation of a terminal related to the present disclosure. The terminal may perform step S1010 and perform step S1020. However, the flowchart does not mean that the terminal performs all the steps or performs only the above steps.

Referring to FIG. 10, in an embodiment of the present disclosure, a method of transmitting a feedback signal from a reception terminal to a transmission terminal in a wireless communication system includes the reception terminal receiving a reference signal from the transmission terminal (S1010) and the reception terminal transmitting the feedback signal based on the reference signal to the transmission terminal (S1020). In addition, the feedback signal may be transmitted based on compensation for a phase change which occurs when receiving the reference signal.

Compensation for the phase change will be described by the following description and/or Method 2 to be described later.

For example, compensation for the phase change may be rotation by a phase based on a time difference between a first fast Fourier transform (FFT) window for transmission of the reference signal of the transmission terminal and a second FFT window for reception of the reference signal of the reception terminal. Specifically, the transmitting the feedback signal to the transmission terminal may include the reception UE transmitting the feedback signal using the timing of the second FFT window for reception of the reference signal.

As another example, compensation for the phase change is expressed by aₖ exp(j2π(k−x)Δfδ), aₖ denotes a complex value of the reference signal transmitted in a k-th frequency resource region, x denotes a reference frequency, Δf denotes a spacing between subcarriers, and δ denotes a time difference between a first FFT window and a second FFT window.

Compensation for the phase change is expressed by aₖ exp(j2π(k−x)Δf(δ−θ)), aₖ denotes a value indicating the amplitude of a multi-path channel of a k-th frequency resource region, x denotes a reference frequency, Δf denotes a spacing between subcarriers, δ denotes a time difference between a first FFT window for transmission of the reference signal of the transmission terminal and a second FFT window for reception of the reference signal of the reception terminal, and θ denotes a value indicating a time difference between the second FFT and a third FFT window for transmission of the feedback of the reception UE.

As another example, compensation for the phase change is based on a channel function based on the reference signal, a sequence for compensation for the phase change based on the channel function is expressed by

$${a}_{k} = \frac{λ}{H ( k )} ,$$

the channel function is expressed by H(k)=aₖ exp(jBₖ), aₖ denotes a value indicating the amplitude of a multi-path channel of a k-th frequency resource region, and Bₖ denotes a value of the phase of a multi-path channel of the k-th frequency resource region.

Additionally, the feedback signal may be transmitted by the reception terminal through the same frequency resource as the frequency resource through which the reference signal is received.

Meanwhile, there is at least one other terminal for transmitting different feedback signals to the transmission terminal, as the sensing result of the reception terminal, based on at least one of the identifier (ID) of the transmission terminal or the ID of at least one other UE, selecting transmission resource for transmitting the feedback signal and transmitting the feedback signal through the selected transmission resource may be further included.

The transmitting the feedback signal to the transmission terminal (S1020) may further include configuring a sequence of the feedback signal based on at least one of the ID of the transmission terminal or the ID of the reception terminal and transmitting the feedback signal to the transmission terminal based on the configured sequence.

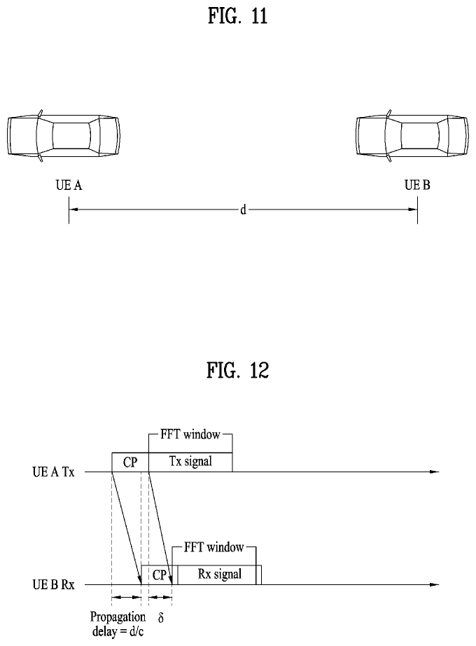

FIG. 11 is a view illustrating a distance d between a transmission terminal (UE A) and a reception terminal (UE B).

In addition, an embodiment of the present disclosure may include calculating a distance d between the transmission terminal and the reception terminal. This will be described in detail below.

An embodiment of the present disclosure includes a method of measuring a distance between and locations of wireless communication devices. In particular, a method of measuring a distance using phase information of radio signals transmitted and received by devices which are distance measurement targets. Although, in the present disclosure, a situation in which signals are transmitted and received using two frequencies is characteristically described, the principles of the present disclosure are applicable to the case where the number of frequencies used for transmission and reception is generalized. In addition, although, in the present disclosure, a situation in which a plurality of frequencies is simultaneously transmitted is assumed, they may be transmitted at predetermined different times and the principles of the present disclosure are applicable in consideration of this.

First, it is assumed that a terminal (e.g., Tx UE) transmits a reference signal at two or more frequencies. For example, the magnitude and phase information of the reference signal may be predetermined by and known to a transmitter and a receiver. As another example, information indicating the magnitude and phase information of the reference signal may be transmitted to a reception terminal (Rx UE). The reception signal of the reference signal in a m-th tone subcarrier in the frequency region may be described by Equation 1 below.

Yₖ=H(k)exp(−j2πkΔfδ)=Aₖ exp(jBₖ)exp(−j2πkΔfδ) [Equation 1]

where, Aₖ and Bₖ respectively denote the amplitude of a multipath channel and a phase response of the multipath channel in a k-th frequency tone, and a channel function H(k) is defined by H(k)=Aₖ exp(jBₖ). Δf denotes a spacing between subcarriers, and δ denotes a time offset between the transmitter and the receiver in the time region.

Here, the time offset may include propagation delay of a radio signal, a sampling time difference between a transmitter and a receiver, etc. In addition, the time offset may be a value indicating a time difference in fast Fourier transform (FFT) window between a transmitter (e.g., Tx UE) and a receiver (e.g., Rx UE). In addition, in this document, multipath channel gain means channel gain which can be obtained on the assumption that the first path of the channel has no delay (e.g., zero delay). In other words, a wireless channel may include a time offset and thus the time offset may be considered separately. Here, propagation delay may indicate a time required for a signal transmitted by the transmitter (e.g., Tx UE) to reach the receiver (e.g., Rx UE) in a communication system.

When the reception terminal (Rx UE) receives signals in two tones, a phase difference in each tone may be expressed by Equation 2 below (In this case, it is assumed that the phases of the multipath channels in the two tones are the same).

Δϕ_{m,n}=∠Yₘ−∠Yₙ=2πΔfδ(n−m) [Equation 2]

In this case, if it is assumed that there is no timing error between the transmitter and the receiver (e.g., Tx UE and Rx UE) and the time offset depends on propagation delay, Equation 2 above for Δϕ_{m,n} may be expressed as shown in Equation 3 below.

$${Δϕ}_{m , n} = 2 πΔ f ( n - m ) \frac{R}{c} \qquad [ Equation 3 ]$$

Through this, the distance R_{m,n} between the two transmission and reception terminals (e.g., Tx UE and Rx UE) may be estimated using Equation 4 below.

$${R}_{m , n} = \frac{c \cdot {Δϕ}_{m , n}}{2 {πΔ w}_{m , n}} \qquad [ Equation 4 ]$$

where, w_{m,n} denotes a frequency difference between two tones, ϕ_{m,n} denotes a phase difference in two tones, and c denotes a constant of light (about 3*10\hat{ }8 [m/s]). Equation 4 above indicates distance estimation in one way ranging. In two way ranging, “½” is multiplied in Equation 4 above. Here, one way ranging may be a method of measuring propagation delay of the transmitter in the receiver on the assumption of synchronization between the transmitter and the receiver (e.g., Tx UE and Rx UE), and two way ranging may be a method of estimating a distance using a phase difference in the transmitter by feedback of the receiver (e.g., Rx UE) in response to the signal of the transmitter (e.g., Tx UE).

Meanwhile, if the phases of the channels between the two tones are different, Equation 2 for a phase difference Δϕ_{m,n} may be rewritten as shown in Equation 5 below.

Δϕ_{m,n}=∠Yₘ−∠Yₙ=2πΔfδ(n−m)+Bₘ−Bₙ [Equation 5]

In addition, Equation 4 for the distance R_{m,n} between the two transmission and reception terminals may be rewritten as shown in Equation 6 below.

$${\hat{R}}_{m , n} = \frac{c \cdot ( {Δϕ}_{m , n} - ( {B}_{m} - {B}_{n} ) )}{2 {πΔ w}_{m , n}} = {R}_{m , n} = - \frac{c ( {B}_{m} - {B}_{n} )}{2 {πΔ w}_{m , n}} \qquad [ Equation 6 ]$$

That is, compared to an original distance, if a phase difference occurs due to the multipath channel, distance estimation error increases.

In order to reduce the phase difference due to the multipath channel, if possible, two tones having the same phase of the channel shall be used. However, in this case, the phase between the two tones due to the distance difference is too little changed (the phase difference is too small) and thus distance estimation is not easy. When the two tones are far apart, distance estimation error increases due to frequency selective fading. Here, frequency selective fading may mean a phenomenon wherein fading selectively appears only in a specific frequency band (fading characteristics may be changed within signal bandwidth, a channel response may be significantly changed in a portion of the signal bandwidth or delay spread may selectively appear for each frequency.

In order to solve this, an embodiment of the present disclosure includes the following.

First, a received signal Yₖ of the k-th frequency region (e.g., tone) may be expressed as shown in Equation 7 below.

Yₖ=H(k)exp(−j2πΔfδ)+W(k) [Equation 7]

where, W(k) denotes noise in the k-th frequency tone.

A conjugate product between the received signal of the k-th tone and the received signal of the (k+m)-th tone may be expressed as shown in Equation 8 below.

$$R ( k , m ) = {Y}_{k} {Y}_{k + m}^{*} = exp ( j 2π m Δ f δ ) H ( k ) {H}^{*} ( k + m ) + Γ ( k ) {W}^{*} ( k + m ) + W ( k ) {Γ}^{*} ( k + m ) + W ( k ) {W}^{*} ( k + m ) \qquad [ Equation 8 ]$$

Γ(k) may be calculated through Equation 9 below, and Γ*(k+m) may be calculated through Equation 10 below.

Γ(k)=H(k)exp(−j2πkΔfδ) [Equation 9]

Γ*(k+m)=H*(k+m)exp(j2π(k+m)Δfδ) [Equation 10]

where, a conjugate product of a frequency response of a k-th tone and a frequency response of a (k+m)-th tone may be rewritten as shown in Equation 11 below.

$$H ( k ) {H}^{*} ( k + m ) = ( {\sum }_{l = 0}^{L - 1} h ( l ) exp ( - j \frac{2 π}{N} lk ) ) \cdot ( {\sum }_{n = 0}^{L - 1} {h}^{*} ( n ) exp ( j \frac{2 π}{N} n ( k + m ) ) ) = {\sum }_{l = 0}^{L - 1} {\vert h ( l ) \vert}^{2} exp ( j \frac{2 π}{N} lm ) + Φ ( k , m ) \qquad [ Equation 11 ]$$

where, N may denote the size of FFT, and L may denote the size of the FFT or the number of multipaths. Here, Φ(k,m) may be calculated using Equation 12 below.

$$Φ ( k , m ) = {\sum }_{l = 0}^{L - 1} {\sum }_{n = 0 , n \neq l}^{L - 1} h ( l ) {h}^{*} ( n ) exp ( - j \frac{2 π}{N} ( ( l - n ) k - nm ) ) \qquad [ Equation 12 ]$$

When L indicates the size of the FFT in Equations 11 and 12, Equations 11 and 12 above may be expressed by Equations 13 and 14 below.

$$\begin{matrix}H ( l ) {H}^{*} ( k + m ) = ( {\sum }_{l = 0}^{N - 1} h ( l ) exp ( - j \frac{2 π}{N} lk ) ) \cdot ( {\sum }_{n = 0}^{N - 1} {h}^{*} ( n ) exp ( j \frac{2 π}{N} n ( k + m ) ) ) = {\sum }_{l = 0}^{N - 1} {\vert h ( l ) \vert}^{2} exp ( j \frac{2 π}{N} lm ) + Φ ( k , m ) & [ Equation 14 ] \\ Φ ( k , m ) = {\sum }_{l = 0}^{N - 1} {\sum }_{n = 0 , n \neq l}^{N - 1} h ( l ) {h}^{*} ( n ) exp ( - j \frac{2 π}{N} ( ( l - n ) k - nm ) ) & [ Equation 14 ]\end{matrix}$$

An average R̅(m) of the conjugate product between the k-th tone and the (k+m)-th tone may be calculated using Equation 15 below.

$$\overline{R} ( m ) = E ( R ( k , m ) ) = exp ( j 2 π m Δ f δ ) E ( H ( k ) {H}^{*} ( k + m ) ) = exp ( j 2 π m Δ f δ ) \underbrace{{\sum }_{l = 0}^{L - 1} E ( {\vert h ( l ) \vert}^{2} ) exp ( j \frac{2 π}{N} lm )}_{S ( m )} \qquad [ Equation 15 ]$$

where, N may denote the size of FFT, and L may denote the size of the FFT or the number of multipaths.

When L indicates the size of the FFT in Equation 15, Equation 15 above may be expressed by Equation 16 below.

$$\overline{R} ( m ) = E ( R ( k , m ) ) = exp ( j 2 π m Δ f δ ) E ( H ( k ) {H}^{*} ( k + m ) ) = exp ( j 2 π m Δ f δ ) \underbrace{{\sum }_{l = 0}^{N - 1} E ( {\vert h ( l ) \vert}^{2} ) exp ( j \frac{2 π}{N} lm )}_{S ( m )} \qquad [ Equation 16 ]$$

where, if it is assumed that there is no correlation between different channel taps, E(Φ(k,m))=0. Accordingly, as shown in Equation 12, a phase change S(m) by the multipath channel may be compensated using the phase value in the m-th tone after inverse fast Fourier transform (IFFT) operation of a channel delay profile. For reference, R̅(m) may be obtained by averaging the conjugate product between two tones separated by a spacing m. That is, the reception terminal may obtain δ (time offset) by dividing a predetermined constant by a value obtained by subtracting the phase value of S(m) from the phase value of the average of the conjugate product between the two tones separated by the spacing m.

Meanwhile, S(m) may be calculated using Equation 17 below.

$$S ( m ) = {\sum }_{l = 0}^{L - 1} E ( {\vert h ( l ) \vert}^{2} ) exp ( j \frac{2 π}{N} lm ) \qquad [ Equation 17 ]$$

where, N may denote the size of FFT, and L may denote the size of the FFT or the number of multipaths.

When L indicates the size of the FFT in Equation 17, Equation 17 above may be expressed by Equation 18 below.

$$S ( m ) = {\sum }_{l = 0}^{N 311} E ( {\vert h ( l ) \vert}^{2} ) exp ( j \frac{2 π}{N} lm ) \qquad [ Equation 18 ]$$

A timing difference between the transmission terminal (Tx UE) and the receiver UE (Rx UE) and a distance d between the two terminals may be obtained through Equations 19 and 20 below.

The timing difference between the terminals is calculated through Equation 19 below.

$$\hat{δ} = \frac{∠ \overline{R} ( m ) ∠S ( m )}{2 π m Δ f} \qquad [ Equation 19 ]$$

The distance d between the UEs is calculated through Equation 20 below.

$$d = \frac{c \cdot ( ∠ \overline{R} ( m ) - ∠S ( m ) )}{2 π m Δ f} \qquad [ Equation 20 ]$$

The distance d between the two terminals (e.g., Tx UE and Rx UE) is measured on the assumption that the transmission time points of the two terminals are the same. If this assumption is not present, the reception terminal shall transmit a specific signal again, in order for the transmission terminal to measure the distance from the counterpart UE. For example, even if all transmission and reception terminals transmit signals based on global navigation satellite system (GNSS) timing, an actual transmission time point may not exactly match according to the clock error of the terminal. In this case, even if the signal of the transmission terminal is transmitted with predetermined time delay, the delay time may not indicate a distance between the terminals. Accordingly, in this case, the UE A may transmit a specific signal and the UE B may feed back the specific signal, thereby estimating the exact distance between the UE A and the UE B.

The following operation of the UE is proposed based on the above description.

Method 1) Transmission of Reference Signal (e.g., Positioning RS and/or Ranging RS)

The transmission terminal (Tx UE) of the present disclosure may transmit the reference signal to the reception terminal (Rx UE). The specific UE (e.g., Tx UE) transmits the reference signal (RS) in a tone spaced apart at a spacing L in the frequency region. In this case, a size of an RB on which the RS is transmitted may be represented by M. (For example, M may indicate the number of RBs corresponding to the same frequency region). Here, M and/or L may be predetermined or pre-configured and may be determined by the transmission terminal (Tx UE) according to the situation of the channel. For example, if a probability that a channel is a non-line-of-sight (NLOS) channel is high (or if it is determined that channel state information feedback from a counterpart UE is NLOS), L and/or M may be set to a large value. L may be pre-configured by a network for each resource pool. Here, the network may be an eNB or a gNB. Unless otherwise noted in the following description, the network is referred to as a fixed node connected to a core network, and the network may signal specific control information to a neighboring terminal. Here, L may be set large in consideration of multiplexing with several terminals, and L may be determined based on the number of terminals. To this end, for example, the network may configure the L and/or M value for each carrier through physical layer and higher layer signaling. As another example, the UE may configure the L and/or M value for each resource pool or slot. Here, higher layer signaling may be RRC signaling. In addition, NLOS may be a state in which a transmit antenna and a receive antenna are not located in a straight line to face each other within the beamwidth of the antenna or a state in which a line of sight (LOS) condition in which there is no obstacle on a propagation path between a transmitter and a receiver is not satisfied.

In direct communication between terminals (e.g., D2D, V2X, etc.), an RS for positioning/ranging (e.g., PRS or ranging RS) may be allocated to continuous tones in the frequency region. For example, the RS may be transmitted through resources corresponding to continuous indices. This is because inband emission interference may occur less when transmitted in continuous tones in the frequency region. However, in order to increase SNR gain per resource (e.g., resource element (RE), tone or subcarrier) when the RS is transmitted, it may be discontinuous in the frequency region from the viewpoint of a specific symbol. Meanwhile, how many symbols are used to transmit the positioning/ranging RS or on which symbol the positioning/ranging RS is transmitted may be predetermined, may be determined by the transmission terminal (Tx UE) or may be determined by the network.

The UE may transmit the positioning/ranging RS (e.g., PRS or ranging RS) without using all frequency resources on a specific component carrier (CC). This may be referred to narrow band transmission. Conversely, transmission using the entire band in the CC or transmission in the frequency region having a predetermined threshold or more may be referred to as wide band transmission. The terminal may determine whether narrow band transmission or wide band transmission is performed according to the interference situation from neighboring UEs or the channel state. For example, a transmission method which may be used when a channel busy ratio (CBR) or SNR measured by the terminal in a specific resource region (e.g., a resource region in which the ranging/positioning RS is transmitted) is less than a predetermined threshold may be predetermined or may be signaled by the network.

When the transmission terminal (Tx UE) transmits the ranging/positioning RS, the location of the RE on which the RS is transmitted (e.g., time, time shift, frequency, frequency shift, etc.) and/or the sequence of the RS may be determined according to at least one of the ID of the transmission terminal (Tx UE), the type of the terminal, the type of the service or the type of the application. For example, the location of the RE on which the RS is transmitted or the RS initialization parameter may be determined based on the ID (UE ID) of the transmission terminal.

In this case, a set of RSs transmitted by the transmission terminal (Tx UE) and/or a radio resource region (time region and/or frequency region) may be differently configured according to the GNSS based location information of the terminal. For example, an RS set available when a specific terminal is located in a specific area (e.g., area A) and an RS set available when the specific terminal is located in another specific area (e.g., an area B geographically different from the area A) may be different from each other. Here, different RS sets may mean different sequence sets and may mean that the initialization parameter is differently configured when the sequence is generated.

This is to prevent collision due to different RSs and to improve ranging performance even if the same resource is used, by configuring the terminals in a hidden node range to use different RS sets, in order to solve a hidden node problem (when the terminals outside a sensing range transmit the same ranging signal) when the terminal transmits the ranging signal.

The resource regions are separated in order to reduce near far effect when transmitting a narrow band signal in D2D communication. Here, near far effect may mean a phenomenon that the signal of a distant terminal is not received by a signal transmitted by a nearby terminal. A near-far problem (or near-far effect) and/or hearability problem represent the effect of a strong signal from a near signal source making it difficult for the receiver to hear a weak signal from another signal source, and this may occur due to adjacent-channel interference, co-channel interference, distortion, capture effect, dynamic range limitation, etc. Even if OFDM waveform is used, interference may occur in a non-allocated RB due to inband emission. In addition, when a distance between terminals using the same time resource increases or when receive powers of different frequencies are significantly different from the viewpoint of the reception terminal, the near far effect may occur. In this case, when the terminals located at similar positions use the same time resource, the near far effect can be reduced.

Method 2) Time Offset Estimation Method

When the specific reference signal (RS) is transmitted from the transmission terminal (Tx UE) through Method 1, the UE (Rx UE) which has received the specific RS may estimate δ (the time offset of the FFT window between the transmission terminal (Tx UE) and the reception terminal (Rx UE). In this case, the following feedback signal transmission operation may be considered.

The reception terminal may adjust transmission timing such that δ (time offset) becomes 0 or rotate the phase of the transmitted reference signal (RS) by a function for δ (time offset) in order to obtain an equivalent effect.

In this document, the transmitted reference signal (RS) may be represented based on aₖ. Here, aₖ denotes a complex value of the reference signal (RS) transmitted in the k-th frequency resource region (e.g., tone). Here, the following method is proposed in determining the location of the frequency resource region (e.g., tone) used to transmit a reference signal (RS) sequence of a feedback signal transmitted from the reception terminal (Rx UE) and the transmission terminal (Tx UE) and the feedback signal.

Frequency Resource Location Determining Method (Set of k Values at aₖ)

When the reception terminal (Rx E) transmits a feedback signal and/or feedback information to the transmission terminal (Tx UE), a method of transmitting the feedback signal (e.g., feedback RS) at the same location such as resource (e.g., RE, tone, subcarrier, etc.) used by the reference signal (RS) received by the reception terminal is proposed. The feedback signal may be transmitted by the reception terminal through the same frequency resource as the frequency resource through which the reference signal is received. Meanwhile, as described above, aₖ indicates the complex value of the reference signal (RS) transmitted in the k-th frequency resource region (e.g., tone).

This method provides technical effects in that the effect of the channel is canceled using channel reciprocity when transmission is performed by compensating for channel information to be described in the future and implementation complexity of the UE is reduced at the receiver (e.g., Rx UE).

A method of, by a UE, selecting and transmitting one of a plurality of resources linked to a reference signal (RS) transmitted from a transmission terminal to a reception terminal or resource, through which the RS is transmitted, when the reception terminal (Rx UE) transmits a feedback signal to the transmission terminal (Tx UE) is proposed.

An embodiment of the present disclosure may further include selecting transmission resource for transmitting the feedback signal based on at least one of the ID of the transmission terminal or the ID of at least one other UE as the sensing result of the reception terminal when there is at least one other UE (other than the reception UE (Rx UE)) for transmitting a different feedback signal to the transmission terminal (Tx UE), and transmitting the feedback signal through the selected transmission resource.

When a plurality of reception terminals (Ex UE) receives the positioning signal and/or the ranging signal (e.g., PRS or ranging RS) from the transmission terminal (Tx UE) and the plurality of reception terminals (Rx UE) simultaneously transmits feedback signals (or feedback information), a plurality of resources may be configured to prevent collision between the feedback signals (or feedback information) simultaneously transmitted by the plurality of reception terminals (Rx UE), and specific resource may be selected from among the plurality of configured resources by i) through sensing of the transmission terminal (Tx UE) and/or the reception terminal (Rx UE), ii) by implementation of the transmission terminal (Tx UE) and/or the reception terminal (Rx UE) or iii) the identifier (ID) of the transmission terminal (Tx UE) and/or the reception terminal (Rx UE). For example, sensing of the reception terminal (Rx UE) may mean detection (or search) of the plurality of other reception terminals for transmitting the feedback signals (or feedback information) or detection (or search) of the signals transmitted (or broadcast) by the plurality of other reception terminals. As another example, sensing of the reception terminal may mean operation of identifying transmission resources reserved by other terminals or resources used by other terminals through sensing within a sensing window.

RS Sequence Determination Method (Sequence Determination of Feedback Signal)

Transmitting the feedback signal to the transmission terminal of the present disclosure may further include configuring the sequence of the feedback signal based on at least one of the ID of the transmission terminal or the ID of the reception terminal and transmitting the feedback signal to the transmission terminal based on the configured sequence.

A pseudo random sequence mapped to aₖ may be generated based on i) the ID of the transmission terminal, ii) based on the ID of the reception terminal which has received this, and iii) based on the IDs of the two UEs. aₖ represents the complex value of the reference signal (RS) transmitted in the k-th frequency resource region (e.g., tone). Meanwhile, the transmission terminal may be a terminal which has transmitted the reference signal (RS) in the above-described process 1, and the reception terminal may be a terminal which has (successfully) received the RS in the above-described process 1.

For example, the initialization parameter of a random sequence may be determined using the ID of the transmission terminal (Tx UE ID) and/or the ID of the reception terminal (Rx UE ID).

The UE for transmitting the feedback signal may not simply transmit aₖ, but may perform transmission after post-processing. Here, post-processing may refer to phase compensation and/or amplitude compensation.

Method of Compensating for Channel

Compensation for the phase change of the present disclosure may be determined based on the channel function based on the reference signal. The reception terminal (Rx UE) may estimate δ (time offset) in Equation 19, and estimate the channel component H(k) in Equation 7 above using the same. In this case, as shown in Equation 21 below, the sequence may be transmitted after dividing aₖ by the channel component H(k).

$${a}_{k} \frac{λ}{H ( k )} \qquad [ Equation 21 ]$$

where, λ is a parameter for power normalization. In addition, for example, the) channel component H(k) may be defined by H(k)=Aₖ exp (jBₖ) aₖ may be a value indicating the amplitude of the multipath channel of the k-th frequency resource region, and Bₖ may be a value indicating the phase of the multipath channel of the k-th frequency resource region.

Alternatively, only the phase value of the channel may be compensated, which may be expressed by Equation 22 below.

aₖ exp(−jBₖ) [Equation 22]

In the above method, since the terminal which receives the feedback signal can observe only the phase change due to propagation delay, without the channel component, the calculation process of Equations 15 to 20 may be omitted. Accordingly, it is possible to reduce implementation complexity of the reception terminal.

In this case, the reception terminal may estimate δ (time offset). At this time, the distance d between the transmission and reception terminals are not directly estimated, but a time offset difference is estimated.

Accordingly, when only (the phase value of) the channel is compensated and the reference signal (RS) is transmitted, δ (time offset value) may be explicitly signaled. δ (time offset value) may be explicitly encoded in a specific field and transmitted, but operation of performing transmission by changing the phase of the transmitted RS or operation of imposing delay on the transmitted signal in consideration of δ (time offset) is possible. This operation will be described below.

Method of Compensating for Time Offset

FIG. 12 is a view illustrating a δ (time offset) and propagation delay of a FFT window between a transmission terminal (UE A) and a reception terminal (UE B) according to an embodiment of the present disclosure.

The reception terminal may transmit the feedback signal based on the reference signal received from the transmission terminal to the transmission terminal, and the feedback signal may be transmitted based on compensation for the phase change occurring when the reference signal is received.

Compensation for the phase change may be rotation by a phase based on a time difference between a first fast Fourier transform (FFT) window for transmission of the reference signal of the transmission terminal and a second FFT window for reception of the reference signal of the reception terminal. Here, the reception terminal transmitting the feedback signal to the transmission terminal may be the case where the reception terminal transmits the feedback signal using the timing of the second FFT window for reception of the reference signal.

In order to obtain an equivalent effect without changing the FFT window of the reception terminal (Rx UE), the phase of the RS rotates by −δ. This may be expressed by Equation 23 below.

aₖ exp(j2π(k−x)Δfδ) [Equation 23]

Meanwhile, as described above, aₖ represents the complex value of the reference signal (RS) transmitted in the k-th frequency resource region (e.g., tone). In Equation 23, x denotes the index of a reference tone, this value may be fixed to a specific value (e.g., x=0), and the specific tone may be designated as a reference tone and/or a reference point in the frequency region in which the transmission terminal (Tx UE) transmits the reference signal (RS). For example, the transmission terminal (Tx UE) may configure a specific tone corresponding to i) the lowest subcarrier index of the tone in which the RS is transmitted or ii) the lowest subcarrier index of the RB, on which the RS is transmitted, as a reference tone and/or a reference point. Since the phase difference between the tones needs to be a certain value, the x value (index of the reference tone) only needs to be a predetermined constant from the viewpoint of the terminal for transmitting the reference signal (RS). In addition, in Equation 23, Δf may denote a spacing between subcarriers. Here, the subcarriers may be a frequency region in which a plurality of reference signals is transmitted.

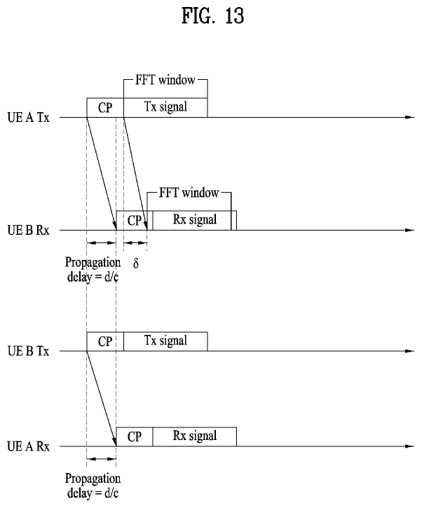

Since the above method obtains the same effect as effectively transmitting δ (time offset) in advance in the time region, the counterpart UE can estimate propagation delay. This is shown in FIG. 13.

FIG. 13 is a view illustrating a δ (time offset) and propagation delay of a FFT window between a transmission terminal (UE A) and a reception terminal (UE B) according to another embodiment of the present disclosure.

The reception terminal may transmit the feedback signal based on the reference signal received from the transmission terminal to the transmission terminal, and the feedback signal may be transmitted based on compensation for the phase change occurring when the reference signal is received.

Meanwhile, if a FFT window when UE B (Rx UE) receives an RS from UE A (Tx UE) and a FFT window when the RS is fed back are different, the phase value may be differently set in consideration of this. The reception terminal (UE B) may transmit the feedback signal (RS sequence) to the transmission terminal (UE A) based on Equation 24 below.

aₖ exp(j2π(k−x)Δf(δ−θ)) [Equation 24]

where, aₖ denotes a value indicating the amplitude of the multipath channel of the k-th frequency resource region, x denotes a reference frequency, and Δf denotes a spacing between subcarriers.

δ may be a time difference between a first FFT for transmission of the reference signal of the transmission terminal and a second FFT window for reception of the reference signal of the reception terminal.

θ may indicate a difference between an FFT window at the time of reception and an FFT window at the time of transmission. For example, θ may be a value indicating a time difference between the second FFT window and a third FFT window for transmission of the feedback signal of the reception terminal. The θ value may be set in consideration of the case where the FFT window is changed when the terminal simultaneously feeds back signals from multiple terminals.

Meanwhile, the reception terminal of the present disclosure may simultaneously perform correction of the time offset and correction of the channel using Equation 25 below.

$${a}_{k} \frac{λ}{{A}_{k} exp ( {jB}_{k} )} exp ( j 2 π ( k - x ) Δ f ( δ - θ ) ) \qquad [ Equation 25 ]$$

Alternatively, the reception terminal may perform correction of only the phase information of the channel using Equation 26 below.

aₖλ exp(−jBₖ)exp(j2π(k−x)Δf(δ−θ)) [Equation 26]

The method related to Equations 25 and 26 above provides technical effects in that explicit signaling of δ (time offset) is not required and, at the same time, the channel is compensated, thereby reducing computational complexity in a receiver (e.g., UE B (Rx UE)).

Meanwhile, as in the above method, when transmission is performed by processing the transmitted positioning/ranging RS again, the RS cannot be used for the purpose of data demodulation. In this case, a known sequence for data demodulation may be transmitted together.

Method 3) The transmission terminal (Tx UE) which has received the RS from the reception terminal (Rx UE) through Methods 1 and 2 may measure a distance d from a specific UE through Equations 19 and 20.

Through the above-proposed methods, an embodiment of the present disclosure may be used for measurement of the distance between terminals and groupcast/broadcast/multicast HARQ ACK/NACK transmission. The terminal may take conjugate of the channel using channel information obtained while receiving data, thereby reducing destructive interference.

In addition, the present disclosure proposes a method of efficiently a HARQ feedback signal when transmitting groupcast packets and/or broadcast packets.

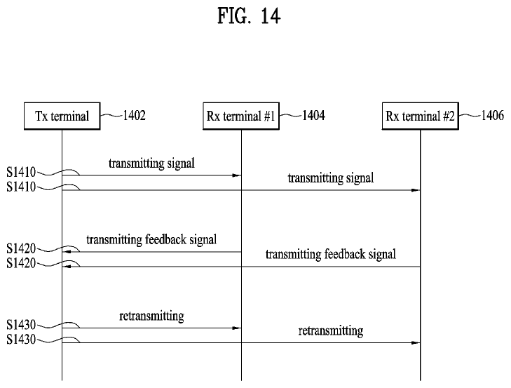

FIG. 14 is a flowchart illustrating an embodiment of the present disclosure.

Referring to FIG. 14, a method of receiving a feedback signal by a transmission terminal in a wireless communication system according to an embodiment of the present disclosure may include the transmission terminal 1402 transmitting a signal (e.g., a reference signal) to a plurality of reception terminals 1404 and 1406 (S1410), the plurality of reception terminals 1404 and 1406 transmitting a plurality of feedback signals based on the reference signal to the transmission terminal 1402 (S1420) and the transmission terminal 1402 retransmitting the signal (e.g., the reference signal) to the plurality of reception terminals (S1430). Here, each of the plurality of feedback signals may include a signal, to which different phase compensation applies. For example, the phase compensation is based on a channel function based on the reference signal, a sequence for the phase compensation based on the channel function is expressed by

$${a}_{k} \frac{λ}{H ( k )} ,$$

The channel function H(x) is expressed by H(k)=Aₖ exp(jBₖ), aₖ denotes a complex value of a sequence transmitted in a k-th tone, Aₖ denotes the amplitude of the multipath channel of the k-th frequency resource region, Bₖ denotes a value indicating the phase of the multipath channel of the k-th frequency resource region, denotes a parameter for power normalization. As another example, the sequence for phase compensation is expressed by aₖ exp(−jX), and X may be an average value of phase values obtained through channel estimation.

In addition, the feedback signal may indicate only negative acknowledge (NACK). That is, an embodiment of the present disclosure may use NACK only HARQ feedback. In addition, a channel used for phase compensation of the plurality of feedback signals may be determined based on a reference antenna port. To this end, the method may further include the transmission terminal 1402 transmitting information on the reference antenna port to the plurality of terminals 1404 and 1406 through physical layer signaling or higher layer signaling.

In addition, the reception terminal may be configured to randomize a phase compensation value applied to transmission of the plurality of feedback signals, when channel estimation accuracy is lower than a predetermined threshold.

In the present disclosure, a method of efficiently performing HARQ feedback in a communication system for transmitting groupcast/broadcast/multicast packets will be described. In groupcast/broadcast/multicast, unlike unicast, packets transmitted by the transmission terminal 1402 are received by the plurality of reception terminals 1404 and 1406. In this case, whether reception of packets or CB of each terminal is successfully performed may vary according to the channel condition, pathloss or shadowing of each terminal. When HARQ ACK/NACK feedback resource is individually configured for each terminal, too many feedback resources may be required.

In the case of groupcast/broadcast/multicast, if only reception terminals in which NACK has occurred in target coverage or group transmit NACK to the transmission terminal through shared resources (e.g., NACK only HARQ feedback), the amount of transmitted feedback signals can be reduced compared to the case where an individual terminal feeds back both HARQ ACK/NACK.

However, if HARQ feedback information is transmitted through the shared resource, the signal may not be properly detected by destructive interference of a radio channel.

The present disclosure proposes a method of solving destructive interference when a plurality of terminals performs HARQ feedback through shared resource.

The present disclosure proposes a method of increasing a packet transfer rate of a transmission terminal and improving link reliability by transmitting ACK or NACK when a terminal receives groupcast/broadcast/multicast packet. In groupcast/broadcast/multicast, since there is a plurality of reception terminals, the plurality of terminals transmits HARQ ACK/NACK information. If resource for transmitting HARQ ACK/NACK information is shared between terminals and a terminal transmits a specific sequence, a packet transmission terminal may detect receive power (or receive energy) of the sequence and determine whether the packet is successfully received. If some of a plurality of target reception terminals do not successfully decode the packet (that is, reception is not successfully performed) and the receive power (or receive energy) of the NACK signal is equal to or greater than a predetermined threshold, the packet transmission terminal may detect that some target reception terminals did not successfully perform decoding, and perform packet retransmission (that is, the packet transmission terminal may retransmit the packet to the some target reception terminals). In this case, if radio channels are different when the plurality of terminals transmits ACK/NACK signals, the signal may not be properly received due to destructive interference. For example, if a channel between the terminals has a phase difference of 180 degrees, a sum of the two signals becomes 0 and thus no signal cannot be detected (that is, a plurality of ACK/NACK signals transmitted by the plurality of terminals may be cancelled).

Therefore, the present disclosure proposes a method of cancelling destructive interference of a channel between different terminals using radio channel information of a terminal which receives packets.

For example, the process proposed by the present disclosure will now be described.

First, the transmission terminal 1402 transmits specific packets to the plurality of reception terminals 1404 and 1406. Information indicating resources for feedback (e.g., resources to transmit feedback), sequence information, etc. may be configured by the transmission terminal 1402 or a resource relationship may be predetermined. In this case, it is assumed that the reception terminal transmits a signal through common resource.

Next, the reception terminals 1404 and 1406 compensate for channel components in a specific signal using a channel estimated from resource, through which packets are received, using channel reciprocity and transmit signals. In this case, i) both an amplitude and a phase may be compensated, and ii) only the phase may be compensated. In this case, phase compensation may be performed based on the channel estimated from individual resource (e.g., RE) and compensation may be performed using an average of a plurality of resources (e.g., REs).

Next, the transmission terminal 1402 detects power (or energy) of feedback signals transmitted by the (plurality of) reception terminals 1404 and 1406 or receive power applied to a specific sequence and determine whether there is a terminal satisfying a specific condition. If the specific condition is HARQ NACK, the transmission terminal 1402 performs retransmission.

In addition, the present disclosure proposes the following operations of the terminal.

Method 4) First, a terminal for transmitting packets transmits packets through specific time and frequency resources.

In this case, the packets may be transmitted in units of transport blocks (TB s), and one TB may be transmission of units of code block groups (CBGs) divided into several code block (CB) units.

In a control signal (e.g., PSCCH) of the transmission terminal or separate control information piggybacked on a higher layer signal (e.g., MAC CE) or data, configuration information such as information on resources for transmitting the feedback signal, the form of a sequence (e.g., the length of the sequence, resource location, etc.) transmitted when transmitting the feedback signal, a sequence identifier (e.g., sequence ID) or initialization information may be signaled to the plurality of reception terminals. Alternatively, feedback signal transmission resource may be determined in association with resource of a data signal.

When there is no data to be transmitted by a specific terminal, dummy packets may be transmitted so that a (single or multiple) reception terminal may feed back specific information. Alternatively, a specific terminal may transmit a signal requesting feedback of specific information to a (single or multiple) reception terminal. For example, when determining whether there is a terminal satisfying a specific information among neighboring terminals, it may be a signal for transmitting a query for the condition. Here, when the terminal is a vehicle or included in the vehicle, the specific condition may be a condition for the movement speed/direction of the terminal or vehicle.

In this case, frequency resources for transmitting the feedback signal by the (single or multiple) reception terminals may be associated with resources for transmitting data. For example, when data transmission resources for data transmission are continuous frequency resources from an N-th RB to an (N+x)-th RB, the resources for transmitting the feedback signal may be limited to some resources of the data transmission RBs. The time and/or frequency resources for transmitting the feedback signal may be directly indicated by the packet transmission terminal (explicit indication), or may be indirectly or implicitly determined using resource allocation information and other control information of the packet transmission terminal. Alternatively, the transmission terminal may indicate some candidate resources to the (single or multiple) reception terminal, and the (single or multiple) reception terminal for transmitting the feedback information may select feedback signal transmission resources from among the candidate resources.

In addition, the packet transmission terminal may indicate an antenna port which is a reference used when the channel is compensated and the sequence is transmitted in Method 5 below through a control signal or a higher layer signal. Such an antenna port may be referred to as a feedback reference antenna port. For example, when a terminal transmits a PSSCH, multiple antenna ports may be configured for Tx diversity or multi-layer transmission. In this case, the antenna port for feedback transmission of the packet reception terminal may be preconfigured. Alternatively, such a configuration may be commonly indicated to terminals by a network (e.g., a base station such as eNB or gNB). For example, the packet transmission terminal may signal information indicating the antenna port which is the reference when performing channel compensation or whether channel compensation operation is performed when performing HARQ feedback, through a control signal. In this case, indicating the feedback reference antenna port means that a (single or multiple) reception beamformer uses a beam weight used for the corresponding (antenna) port when the transmission terminal receives the feedback signal later, in order to use channel reciprocity. For example, when indicating the feedback reference antenna port, one or multiple ports among the DMRS ports of the PSSCH or the DMRS ports of the PSCCH may be indicated. As another example, when indicating the feedback reference antenna port, a separate measurement RS may be transmitted to indicate that the channel of the RS is used for feedback signal transmission. For example, an RS (e.g., CSI-RS) for CSI measurement or a sound reference signal (SRS) may be transmitted as an unprecoded RS and the corresponding RS (antenna) port may be signaled to the (single or multiple) packet reception terminal, such that the channel estimation result of the corresponding (antenna) port may be used for feedback signal transmission.

Method 5) (channel compensated HARQ feedback signal) The reception terminal transmits HARQ feedback information at a resource location explicitly/implicitly designated by the transmission terminal. In this case, the reception terminal transmits (feedback) HARQ feedback information to the transmission terminal using channel information obtained when the transmission terminal receives the packets. Here, HARQ feedback information may be HARQ ACK/NACK information, and, in the case of transmission of TB units, the number of resources and/or signals for HARQ feedback may be determined according to the number of (transmitted) TBs. In addition, in the case of transmission of CB units, the number of resources and/or signals for HARQ feedback may be determined according to the number of (transmitted) CBs. For example, in transmission of TB units, if transmission of two TBs is performed due to MIMO transmission, for HARQ ACK/NACK feedback, two feedback resources and a feedback sequence may be configured. As another example, if transmission of CB units is performed and transmission of four CBGs is performed, four (e.g., NACK only HARQ feedback) or a multiple of 4 feedback resources (e.g., individual transmission of ACK and NACK) may be configured.

In this case, the UE may decode the packets received thereby and transmit HARQ ACK/NACK information for each TB or CB. In direct communication or sidelink communication between the terminals, a channel, through which the feedback information is transmitted, may be referred to as a physical sidelink feedback channel (PSFCH). In this case, a predetermined sequence may be transmitted. At this time, when the same sequence is transmitted for each terminal, destructive interference may occur due to different channels between terminals. Here, destructive interference means a phenomenon that the directions of the channels are different and thus a sum of the signals transmitted by different terminals is smaller than an individual signal. In this case, the packet transmission terminal cannot properly detect the HARQ feedback signal.

At this time, in order to reduce destructive interference, an individual reception terminal may transmit a HARQ feedback signal using channel information estimated thereby. When a channel estimated at a k-th subcarrier is H(k)=Aₖ exp(jBₖ), the terminal may transmit a signal for compensating for it (in the k-th subcarrier), inducing a channel sum between different terminals in the same direction. More specifically, the method described in the positioning signal transmission may be used.

Method of Determining HARQ Feedback Sequence

A pseudo random sequence mapped to aₖ may be generated based on the ID of the transmission terminal (the terminal which has transmitted the RS in Method 4), the ID of the terminal which has received the same (the terminal which has successfully received the RS of step 1) or the IDs of the two terminals. Alternatively, the HARQ feedback signal may be generated using the ID of the packet and the HARQ process ID. Here, ak(aₖ) may be a value indicating the amplitude of the multipath channel of the k-th frequency resource region.

For example, the initialization parameter of the random sequence may be determined using the ID of the transmission terminal and/or the packet ID and/or the HARQ process ID.

In the present disclosure, the method of generating the pseudo random sequence is not limited. However, in order to transmit specific feedback information in groupcast or broadcast, the terminals may use a common pseudo random sequence. This has two purposes: a purpose of distinguishing which group of terminals performs feedback for which packet and a purpose of reducing interference using a random sequence even if feedback resources overlap.

The terminal for transmitting the feedback signal does not simply transmit aₖ but performs transmission after post-processing (phase and/or amplitude compensation).

An embodiment of the present disclosure relates to a method of compensating for a channel. When a reception terminal receives packets, a channel component H(k) may be estimated. In this case, a sequence may be transmitted after dividing aₖ by a channel component.

$${a}_{k} \frac{λ}{H ( k )} \qquad [ Equation 27 ]$$

where, λ is a parameter for power normalization. This may be configured not to exceed maximum transmit power. Alternatively, this may be configured such that average transmit power becomes a predetermined level. At this time, maximum transmit power for transmitting the feedback signal or average transmit power for transmitting the feedback signal may be directly indicated by the packet transmission terminal, may be determined by a power control function in consideration of pathloss or may be configured by a network (e.g., a base station such as eNB or gNB).

Alternatively, as shown in Equation 28 below, only the phase value of the channel may be compensated. Here, Bk may be a value indicating the phase of the multipath channel of the k-th frequency resource region.

aₖ exp(−jBₖ) [Equation 28]

Alternatively, as shown in Equation 29 below, the channel may be compensated using the average phase value of the channel estimated by the UE from the viewpoint of the average. Here, aₖ may be a value indicating the amplitude of the multipath channel of the k-th frequency resource region, and X may be an average (average value) of phase values obtained through channel estimation.

aₖ exp(−jX) [Equation 29]

Alternatively, a representative phase compensation value may be obtained for each RE group, by grouping REs.

For example, the conjugate of channel estimation for each RE may apply to each PSFCH RE, but noise suppression may be a little weak in estimation. Since a PSFCH may be transmitted at a frequency different from that of a PSSCH (for example, there may be cross-carrier scheduling), for example, one average value of a channel phase in the entire PSSCH transmission band is calculated and may be used for phase rotation of all PSFCH REs. Alternatively, X may be determined using the average value of the channel phase in the band in which the PSFCH is transmitted among bands in which the PSSCH is transmitted. Here, X may be an average (average value) of phase values obtained through channel estimation of Equation 29.

In this case, X, Bₖ or

$$\frac{λ}{H ( k )}$$

value may differ between terminals. In addition, these values may be for channel information derived from a specific antenna port described in Method 4 above.

If the channel estimation performance of the terminal is very bad, the corresponding compensation value may be determined by the terminal. At this time, the rule may be made such that compensation is performed with a different value for every feedback transmission.

Alternatively, the terminal for transmitting the packets may indicate how to compensate for the channel component to the packet reception terminal or set a condition for transmitting the feedback signal using the channel component. Alternatively, whether to apply the detailed method of using the channel component when transmitting the feedback signal may be indicated by the transmission terminal or may be determined by the terminal for transmitting the feedback signal. For example, if the terminal moves very fast and time resource for performing HARQ feedback is separated from a point in time when the packets are received by a predetermined period or more, the channel may be rapidly changed. Therefore, it may be difficult to completely obtain channel reciprocity. In this case, as shown in Equation 29 above, by compensating for the channel value using a phase value averaged for some REs, it is possible to increase noise suppression performance of the feedback signal compared to compensation for destructive interference of the channel.

Method 6) The packet transmission terminal may detect the feedback signal transmitted by a single or a plurality of reception terminals and determine whether there is a terminal satisfying a specific condition. For example, when the feedback is HARQ NACK and the single or the plurality of reception terminals transmitted a sequence aₖ (k∈S_{FB}) corresponding NACK, the packet transmission terminal may determine that there is a reception terminal which does not properly receive the packets, and perform HARQ retransmission (that is, the packet transmission terminal may retransmit the packets to the plurality of reception terminals). Here, S_{FB} means a set of REs for transmitting a feedback signal.

The proposed method is not limited to HARQ feedback and is applicable to the case where a single or a plurality of terminals feeds information on specific operation back to a transmission terminal. For example, when the reception terminal has a temperature sensor and a specific terminal determines whether there is a terminal having temperature exceeding a predetermined threshold, the terminal having the predetermined temperature or more may transmit a predetermined specific sequence. In this case, a method of performing transmission by compensating for channel information received in a sequence for each individual terminal may be used. Through this method, even if a plurality of terminals transmits the feedback through common resource, destructive interference can be reduced and thus detection performance of the feedback signal may be improved.

The disclosed matters and/or embodiments of the present disclosure may be regarded as one proposed method or a combination of the disclosed matters and/or embodiments may be regarded as a new method. In addition, the disclosed matters are not limited to the embodiments of the present disclosures and are not limited to a specific system. All (parameters) and/or (operations) and/or (a combination of each parameter and/or operation) and/or (whether to apply the corresponding parameter and/or operation) and/or (whether to apply a combination of each parameter and/or operation) of the present disclosure may be (pre)configured through higher layer signaling and/or physical layer signaling from a base station to a UE or may be predefined in a system. In addition, each of matters of the present disclosure may be defined as one operation mode, and one of the matters may be (pre)configured through higher layer signaling and/or physical layer signaling from a base station to a UE, such that the base station operates according to the corresponding operation mode. A transmit time interval (TTI) or a resource unit for signal transmission of the present disclosure may correspond to units having various lengths, such as basic unit which is a basic transmission unit or sub-slot/slot/subframe, and the UE of the present disclosure may correspond to devices having various shapes, such as a vehicle, pedestrian UE, etc. In addition, operation of a UE and/or a base station and/or a road side unit (RSU) of the present disclosure is not limited to each device type and is applicable to different types of devices. For example, in the present disclosure, a matter described as operation of a base station is applicable to operation of a UE. Alternatively, a matter applied to direct communication between UEs in the present disclosure may be used between a UE and a base station (for example, uplink or downlink). At this time, the proposed method may be used in communication between a UE and a special UE such as a UE type RSU, a relay node or a base station or communication between special types of wireless devices. In addition, in the above description, the base station may be replaced with a relay node or a UE-type RSU.

Example of Communication System to which the Present Disclosure Applies

The various descriptions, functions, procedures, proposals, methods, and/or operational flowcharts of the present disclosure described in this document may be applied to, without being limited to, various fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

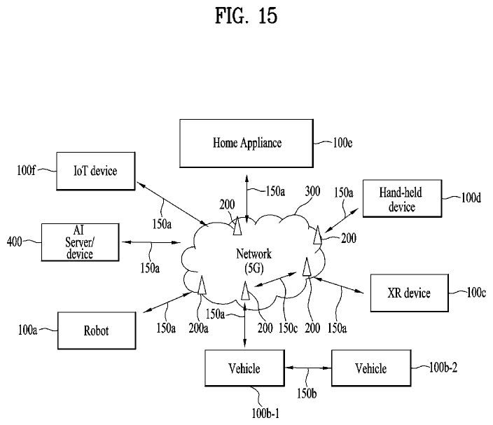

FIG. 15 shows a communication system 1 in accordance with an embodiment of the present disclosure.

Referring to FIG. 15, a communication system to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot (100a), vehicles (100b-1, 100b-2), an eXtended Reality (XR) device (100c), a hand-held device (100d), a home appliance (100e), an Internet of Things (IoT) device (100f), and an Artificial Intelligence (AI) device/server (400). For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device (200a) may operate as a BS/network node with respect to other wireless devices.

The wireless devices (100a˜100f) may be connected to the network (300) via the BSs (200). An AI technology may be applied to the wireless devices (100a˜100f) and the wireless devices (100a˜100f) may be connected to the AI server (400) via the network (300). The network (300) may be configured using a 3G network, a 4G (e.g., LTE) network, or a 5G (e.g., NR) network. Although the wireless devices (100a˜100f) may communicate with each other through the BSs (200)/network (300), the wireless devices (100a˜100f) may perform direct communication (e.g., sidelink communication) with each other without passing through the BSs/network. For example, the vehicles (100b-1, 100b-2) may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices (100a˜100f).

Wireless communication/connections (150a, 150b, 150c) may be established between the wireless devices (100a˜100f)/BS (200), or BS (200)/BS (200). Herein, the wireless communication/connections may be established through various RATs (e.g., 5G NR) such as uplink/downlink communication (150a), sidelink communication (150b) (or, D2D communication), or inter BS communication (e.g. relay, Integrated Access Backhaul (IAB)). The wireless devices and the BSs/the wireless devices may transmit/receive radio signals to/from each other through the wireless communication/connections (150a, 150b). For example, the wireless communication/connections (150a, 150b) may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure Applies

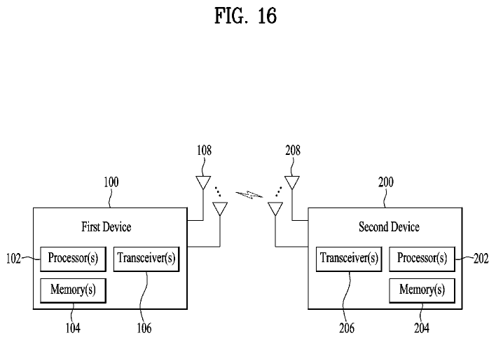

FIG. 16 shows wireless devices in accordance with an embodiment of the present disclosure.

Referring to FIG. 16, a first wireless device (100) and a second wireless device (200) may transmit radio signals through various RATs (e.g., LTE and NR). Herein, {the first wireless device (100) and the second wireless device (200)} may correspond to {the wireless device (100x) and the BS (200)} and/or {the wireless device (100x) and the wireless device (100x)} of FIG. 15.

The first wireless device (100) may include one or more processors (102) and one or more memories (104) and additionally further include one or more transceivers (106) and/or one or more antennas (108). The processor(s) (102) may control the memory(s) (104) and/or the transceiver(s) (106) and may be configured to implement the descriptions, functions, procedures, proposals, methods, and/or operational flowcharts disclosed in this document. For example, the processor(s) (102) may be configured to perform at least one of the methods described above with reference to FIG. 15. For example, the processor(s) (102) may be configured to control the transceiver(s) (106) to receive predetermined information from a second UE and to measure the location of the first wireless device 100 based on the predetermined information. In addition, the predetermined information may be configured to include second reference signal timing difference (RSTD) information of the second wireless device 200. In addition, the processor 102 may be configured to measure the location of the first wireless device 100 based on the first RSTD information of the first wireless device 100 and second RSTD information included in the predetermined information.

In addition, the processor(s) (102) may process information within the memory(s) (104) to generate first information/signals and then transmit radio signals including the first information/signals through the transceiver(s) (106). The processor(s) (102) may receive radio signals including second information/signals through the transceiver (106) and then store information obtained by processing the second information/signals in the memory(s) (104). The memory(s) (104) may be connected to the processor(s) (102) and may store various information related to operations of the processor(s) (102). For example, the memory(s) (104) may store software code including commands for performing a part or the entirety of processes controlled by the processor(s) (102) or for performing the descriptions, functions, procedures, proposals, methods, and/or operational flowcharts disclosed in this document. Herein, the processor(s) (102) and the memory(s) (104) may be a part of a communication modem/circuit/chip designed to implement RAT (e.g., LTE or NR). The transceiver(s) (106) may be connected to the processor(s) (102) and transmit and/or receive radio signals through one or more antennas (108). Each of the transceiver(s) (106) may include a transmitter and/or a receiver. The transceiver(s) (106) may be interchangeably used with Radio Frequency (RF) unit(s). In the present disclosure, the wireless device may represent a communication modem/circuit/chip.

The second wireless device (200) may include one or more processors (202) and one or more memories (204) and additionally further include one or more transceivers (206) and/or one or more antennas (208). The processor(s) (202) may control the memory(s) (204) and/or the transceiver(s) (206) and may be configured to implement the descriptions, functions, procedures, proposals, methods, and/or operational flowcharts disclosed in this document. For example, the processor(s) (202) may process information within the memory(s) (204) to generate third information/signals and then transmit radio signals including the third information/signals through the transceiver(s) (206). The processor(s) (202) may receive radio signals including fourth information/signals through the transceiver(s) (106) and then store information obtained by processing the fourth information/signals in the memory(s) (204). The memory(s) (204) may be connected to the processor(s) (202) and may store various information related to operations of the processor(s) (202). For example, the memory(s) (204) may store software code including commands for performing a part or the entirety of processes controlled by the processor(s) (202) or for performing the descriptions, functions, procedures, proposals, methods, and/or operational flowcharts disclosed in this document. Herein, the processor(s) (202) and the memory(s) (204) may be a part of a communication modem/circuit/chip designed to implement RAT (e.g., LTE or NR). The transceiver(s) (206) may be connected to the processor(s) (202) and transmit and/or receive radio signals through one or more antennas (208). Each of the transceiver(s) (206) may include a transmitter and/or a receiver. The transceiver(s) (206) may be interchangeably used with RF unit(s). In the present disclosure, the wireless device may represent a communication modem/circuit/chip.

Hereinafter, hardware elements of the wireless devices (100, 200) will be described more specifically. One or more protocol layers may be implemented by, without being limited to, one or more processors (102, 202). For example, the one or more processors (102, 202) may implement one or more layers (e.g., functional layers such as PHY, MAC, RLC, PDCP, RRC, and SDAP). The one or more processors (102, 202) may generate one or more Protocol Data Units (PDUs) and/or one or more Service Data Unit (SDUs) according to the descriptions, functions, procedures, proposals, methods, and/or operational flowcharts disclosed in this document. The one or more processors (102, 202) may generate messages, control information, data, or information according to the descriptions, functions, procedures, proposals, methods, and/or operational flowcharts disclosed in this document. The one or more processors (102, 202) may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers (106, 206). The one or more processors (102, 202) may receive the signals (e.g., baseband signals) from the one or more transceivers (106, 206) and obtain the PDUs, SDUs, messages, control information, data, or information according to the descriptions, functions, procedures, proposals, methods, and/or operational flowcharts disclosed in this document.

The one or more processors (102, 202) may be referred to as controllers, microcontrollers, microprocessors, or microcomputers. The one or more processors (102, 202) may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors (102, 202). The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors (102, 202) or stored in the one or more memories (104, 204) so as to be driven by the one or more processors (102, 202). The descriptions, functions, procedures, proposals, methods, and/or operational flowcharts disclosed in this document may be implemented using firmware or software in the form of code, commands, and/or a set of commands.

The one or more memories (104, 204) may be connected to the one or more processors (102, 202) and store various types of data, signals, messages, information, programs, code, instructions, and/or commands. The one or more memories (104, 204) may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories (104, 204) may be located at the interior and/or exterior of the one or more processors (102, 202). The one or more memories (104, 204) may be connected to the one or more processors (102, 202) through various technologies such as wired or wireless connection.

The one or more transceivers (106, 206) may transmit user data, control information, and/or radio signals/channels, mentioned in the methods and/or operational flowcharts of this document, to one or more other devices. The one or more transceivers (106, 206) may receive user data, control information, and/or radio signals/channels, mentioned in the descriptions, functions, procedures, proposals, methods, and/or operational flowcharts disclosed in this document, from one or more other devices. For example, the one or more transceivers (106, 206) may be connected to the one or more processors (102, 202) and transmit and receive radio signals. For example, the one or more processors (102, 202) may perform control so that the one or more transceivers (106, 206) may transmit user data, control information, or radio signals to one or more other devices. The one or more processors (102, 202) may perform control so that the one or more transceivers (106, 206) may receive user data, control information, or radio signals from one or more other devices. The one or more transceivers (106, 206) may be connected to the one or more antennas (108, 208) and the one or more transceivers (106, 206) may be configured to transmit and receive user data, control information, and/or radio signals/channels, mentioned in the descriptions, functions, procedures, proposals, methods, and/or operational flowcharts disclosed in this document, through the one or more antennas (108, 208). In this document, the one or more antennas may be a plurality of physical antennas or a plurality of logical antennas (e.g., antenna ports). The one or more transceivers (106, 206) may convert received radio signals/channels, etc., from RF band signals into baseband signals in order to process received user data, control information, radio signals/channels, etc., using the one or more processors (102, 202). The one or more transceivers (106, 206) may convert the user data, control information, radio signals/channels, etc., processed using the one or more processors (102, 202) from the base band signals into the RF band signals. To this end, the one or more transceivers (106, 206) may include (analog) oscillators and/or filters.

Signal Processing Circuit Example to which the Present Disclosure Applies

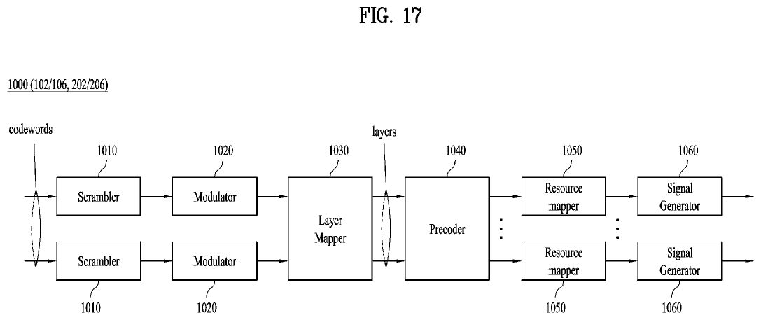

FIG. 17 shows a signal process circuit for a transmission signal in accordance with an embodiment of the present disclosure.

Referring to FIG. 17, a signal processing circuit (1000) may include scramblers (1010), modulators (1020), a layer mapper (1030), a precoder (1040), resource mappers (1050), and signal generators (1060). An operation/function of FIG. 17 may be performed, without being limited to, the processors (102, 202) and/or the transceivers (106, 206) of FIG. 16. Hardware elements of FIG. 17 may be implemented by the processors (102, 202) and/or the transceivers (106, 206) of FIG. 16. For example, blocks 1010˜1060 may be implemented by the processors (102, 202) of FIG. 16. Alternatively, the blocks 1010˜1050 may be implemented by the processors (102, 202) of FIG. 16 and the block 1060 may be implemented by the transceivers (106, 206) of FIG. 16.

Codewords may be converted into radio signals via the signal processing circuit (1000) of FIG. 17. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers (1010). Scramble sequences used for scrambling may be generated based on an initialization value, and the initialization value may include ID information of a wireless device. The scrambled bit sequences may be modulated to modulation symbol sequences by the modulators (1020). A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper (1030). Modulation symbols of each transport layer may be mapped (precoded) to corresponding antenna port(s) by the precoder (1040). Outputs z of the precoder (1040) may be obtained by multiplying outputs y of the layer mapper (1030) by an N*M precoding matrix W. Herein, N is the number of antenna ports and M is the number of transport layers. The precoder (1040) may perform precoding after performing transform precoding (e.g., DFT) for complex modulation symbols. Alternatively, the precoder (1040) may perform precoding without performing transform precoding.

The resource mappers (1050) may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators (1060) may generate radio signals from the mapped modulation symbols and the generated radio signals may be transmitted to other devices through each antenna. For this purpose, the signal generators (1060) may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures (1010˜1060) of FIG. 17. For example, the wireless devices (e.g., 100, 200 of FIG. 16) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Example of Using Wireless Device, to which the Present Disclosure Applies

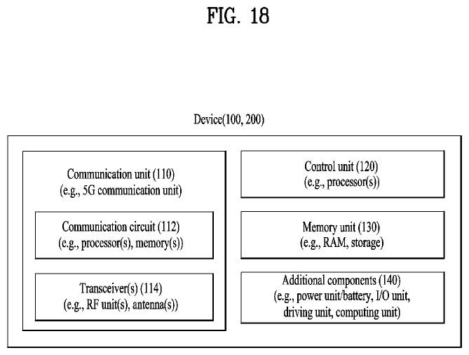

FIG. 18 is a block diagram illustrating a wireless device, to which an embodiment of the present disclosure is applicable. The wireless device may be implemented in various forms according to a use-case/service (refer to FIGS. 15 and 19 to 21).

Referring to FIG. 18, wireless devices (100, 200) may correspond to the wireless devices (100, 200) of FIG. 16 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 16. For example, the transceiver(s) (114) may include the one or more transceivers (106, 206) and/or the one or more antennas (108, 208) of FIG. 16. The control unit (120) is electrically connected to the communication unit (110), the memory (130), and the additional components (140) and controls overall operation of the wireless devices. For example, the control unit (120) may control an electric/mechanical operation of the wireless device based on programs/code/commands/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110). For example, the control unit (120) may be configured to perform at least one of the methods described above with reference to FIGS. 10 and 11. For example, the control unit (120) may be configured to control the communication unit (110) to receive control information from at least one wireless device (200) and to transmit a reference signal to the plurality of base stations based on the control information. Herein, the control information may include information indicating transmission of the reference signal to the wireless device (100) with maximum power. In addition, the location of the wireless device (100) may be configured to be measured by at least one wireless device (200) based on the reference signal.

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 18), the vehicles (100b-1 and 100b-2 of FIG. 18), the XR device (100c of FIG. 18), the hand-held device (100d of FIG. 18), the home appliance (100e of FIG. 18), the IoT device (100f of FIG. 18), a digital broadcast terminal, a hologram device, a public safety device, an MTC device, a medicine device, a fintech device (or a finance device), a security device, a climate/environment device, the AI server/device (400 of FIG. 18), the BSs (200 of FIG. 18), a network node, etc. The wireless device may be used in a mobile or fixed place according to a use-example/service.

In FIG. 18, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 18 will be described in detail with reference to the drawings.

Examples of Mobile Devices to which the Present Disclosure Applies

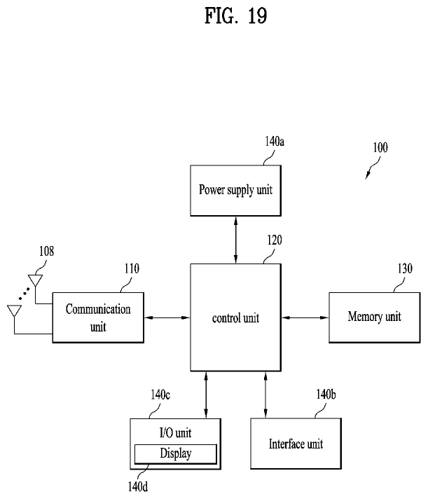

FIG. 19 shows a hand-held device in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 19, a hand-held device (100) may include an antenna unit (108), a communication unit (110), a control unit (120), a memory unit (130), a power supply unit (140a), an interface unit (140b), and an I/O unit (140c). The antenna unit (108) may be configured as a part of the communication unit (110). Blocks 110˜130/140a˜140c correspond to the blocks 110˜130/140 of FIG. 18, respectively.

The communication unit (110) may transmit and receive signals (e.g., data and control signals) to and from other wireless devices or BSs. The control unit (120) may perform various operations by controlling constituent elements of the hand-held device (100). The control unit (120) may include an Application Processor (AP). The memory unit (130) may store data/parameters/programs/code/commands needed to drive the hand-held device (100). The memory unit (130) may store input/output data/information. The power supply unit (140a) may supply power to the hand-held device (100) and include a wired/wireless charging circuit, a battery, etc. The interface unit (140b) may support connection of the hand-held device (100) to other external devices. The interface unit (140b) may include various ports (e.g., an audio I/O port and a video I/O port) for connection with external devices. The I/O unit (140c) may input or output video information/signals, audio information/signals, data, and/or information input by a user. The I/O unit (140c) may include a camera, a microphone, a user input unit, a display unit (140d), a speaker, and/or a haptic module.

As an example, in the case of data communication, the I/O unit (140c) may obtain information/signals (e.g., touch, text, voice, images, or video) input by a user and the obtained information/signals may be stored in the memory unit (130). The communication unit (110) may convert the information/signals stored in the memory into radio signals and transmit the converted radio signals to other wireless devices directly or to a BS. The communication unit (110) may receive radio signals from other wireless devices or the BS and then restore the received radio signals into original information/signals. The restored information/signals may be stored in the memory unit (130) and may be output as various types (e.g., text, voice, images, video, or haptic) through the I/O unit (140c).

Examples of Vehicles or Autonomous Vehicles to which the Present Disclosure Applies

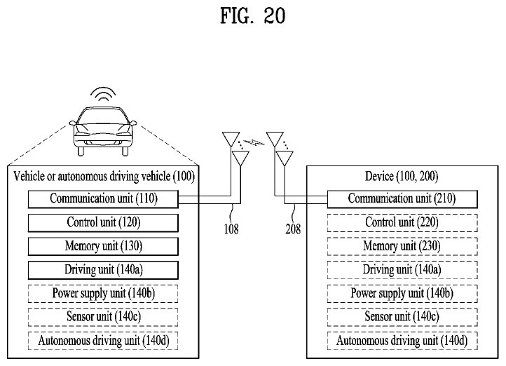

FIG. 20 shows a vehicle or an autonomous vehicle in accordance with an embodiment of the present disclosure. The vehicle or autonomous vehicle may be implemented by a mobile robot, a car, a train, a manned/unmanned Aerial Vehicle (AV), a ship, etc.

Referring to FIG. 20, a vehicle or autonomous vehicle (100) may include an antenna unit (108), a communication unit (110), a control unit (120), a driving unit (140a), a power supply unit (140b), a sensor unit (140c), and an autonomous driving unit (140d). The antenna unit (108) may be configured as a part of the communication unit (110). The blocks 110/130/140a˜140d correspond to the blocks 110/130/140 of FIG. 18, respectively.

The communication unit (110) may transmit and receive signals (e.g., data and control signals) to and from external devices such as other vehicles, BSs (e.g., gNBs and road side units), and servers. The control unit (120) may perform various operations by controlling elements of the vehicle or the autonomous vehicle (100). The control unit (120) may include an Electronic Control Unit (ECU). For example, the control unit (120) may be configured to perform at least one of the methods described above with reference to FIGS. 10 and 11. For example, the control unit (120) may be configured to control the communication unit (110) to receive predetermined information from the device 200 and to measure the location of the vehicle or the autonomous vehicle 100 based on the predetermined information. In addition, the predetermined information may be configured to include second reference signal timing difference (RSTD) information of the device 200. In addition, the processor 102 may be configured to measure the location of the vehicle or the autonomous vehicle 100 based on the first RSTD information of the vehicle or the autonomous vehicle 100 and the second RSTD information included in the predetermined information.

The driving unit (140a) may cause the vehicle or the autonomous vehicle (100) to drive on a road. The driving unit (140a) may include an engine, a motor, a powertrain, a wheel, a brake, a steering device, etc. The power supply unit (140b) may supply power to the vehicle or the autonomous vehicle (100) and include a wired/wireless charging circuit, a battery, etc. The sensor unit (140c) may obtain a vehicle state, ambient environment information, user information, etc. The sensor unit (140c) may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit (140d) may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit (110) may receive map data, traffic information data, etc., from an external server. The autonomous driving unit (140d) may generate an autonomous driving path and a driving plan from the obtained data. The control unit (120) may control the driving unit (140a) such that the vehicle or the autonomous vehicle (100) may move along the autonomous driving path according to the driving plan (e.g., speed/direction control). In the middle of autonomous driving, the communication unit (110) may aperiodically/periodically obtain recent traffic information data from the external server and obtain surrounding traffic information data from neighboring vehicles. In the middle of autonomous driving, the sensor unit (140c) may obtain a vehicle state and/or surrounding environment information. The autonomous driving unit (140d) may update the autonomous driving path and the driving plan based on the newly obtained data/information. The communication unit (110) may transfer information on a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

AR/VR and Vehicle Example, to which the Present Disclosure Applies

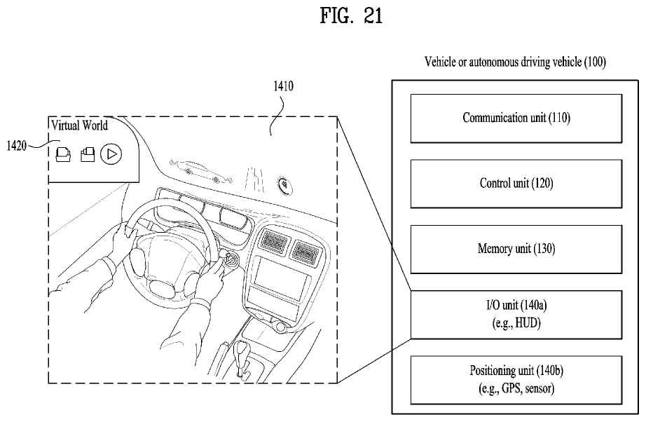

FIG. 21 is a view showing a vehicle, to which another embodiment of the present disclosure is applicable. The vehicle may be implemented as a transport means, an aerial vehicle, a ship, etc.

Referring to FIG. 21, a vehicle (100) may include a communication unit (110), a control unit (120), a memory unit (130), an I/O unit (140a), and a positioning unit (140b). Herein, the blocks 110˜130/140a˜140b correspond to blocks 110˜130/140 of FIG. 21.

The communication unit (110) may transmit and receive signals (e.g., data and control signals) to and from external devices such as other vehicles or BSs. The control unit (120) may perform various operations by controlling constituent elements of the vehicle (100). The memory unit (130) may store data/parameters/programs/code/commands for supporting various functions of the vehicle (100). The I/O unit (140a) may output an AR/VR object based on information within the memory unit (130). The I/O unit (140a) may include an HUD. The positioning unit (140b) may obtain information on the position of the vehicle (100). The position information may include information on an absolute position of the vehicle (100), information on the position of the vehicle (100) within a traveling lane, acceleration information, and information on the position of the vehicle (100) from a neighboring vehicle. The positioning unit (140b) may include a GPS and various sensors.

As an example, the communication unit (110) of the vehicle (100) may receive map information and traffic information from an external server and store the received information in the memory unit (130). The positioning unit (140b) may obtain the vehicle position information through the GPS and various sensors and store the obtained information in the memory unit (130). The control unit (120) may generate a virtual object based on the map information, traffic information, and vehicle position information and the I/O unit (140a) may display the generated virtual object in a window in the vehicle (1410, 1420). The control unit (120) may determine whether the vehicle (100) normally drives within a traveling lane, based on the vehicle position information. If the vehicle (100) abnormally exits from the traveling lane, the control unit (120) may display a warning on the window in the vehicle through the I/O unit (140a). In addition, the control unit (120) may broadcast a warning message regarding driving abnormity to neighboring vehicles through the communication unit (110). According to situation, the control unit (120) may transmit the vehicle position information and the information on driving/vehicle abnormality to related organizations.

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

In this disclosure, the embodiments of the present disclosure have been described centering on a data transmission and reception relationship between a UE and a BS. Such a transmission/reception relationship extends equally/similarly to signal transmission/reception between a terminal and a relay or between a base station and a relay. In this disclosure, a specific operation described as performed by the BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the terms fixed station, Node B, eNode B (eNB), gNode B (gNB), access point, etc. The term terminal may also be replaced with a user equipment (UE), a mobile station (MS) or a mobile subscriber station (MSS).

The embodiments of the present disclosure may be achieved by various techniques, for example, hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, the implementations of the present disclosure may be implemented in the form of a module, a procedure, a function, etc. Software code may be stored in the memory unit and executed by the processor. The memory unit may be located inside or outside the processor and may transmit data to and receive data from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method of receiving a feedback signal by a transmission terminal in a wireless communication system, the method comprising:
the transmission terminal transmitting a reference signal to a plurality of reception terminals; and
the transmission terminal receiving a plurality of feedback signals based on the reference signal from the plurality of reception terminals,
wherein each of the plurality of feedback signals comprises a signal, to which different phase compensation applies.

2. The method of claim 1, wherein a channel used for phase compensation of the plurality of feedback signals is determined based on a reference antenna port.

3. The method of claim 2, further comprising transmitting information on the reference antenna port to the plurality of reception terminals through physical layer signaling or higher layer signaling.

4. The method of claim 3, wherein the information on the reference antenna port indicates at least one of a demodulation reference signal (DMRS) port of a physical sidelink shared channel (PSSCH) or a DMRS port of a physical sidelink control channel (PSCCH).

5. The method of claim 2, wherein the transmission terminal transmits a reference signal or a sounding reference signal (SRS) used for channel state information (CSI) measurement based on the reference antenna port.

6. The method of claim 1,
wherein the phase compensation is based on a channel function based on the reference signal,
wherein a sequence for the phase compensation based on the channel function is expressed by
$${a}_{k} \frac{λ}{H ( k )} ,$$
and
wherein the channel function H(k) is expressed by H(k)=Aₖ exp(jBₖ),
where, aₖ denotes a complex value of a sequence transmitted in a k-th tone, Aₖ denotes an amplitude of a multipath channel of a k-th frequency resource region, Bₖ denotes a value of a phase of a multipath channel of the k-th frequency resource region, and λ denotes a parameter for power normalization.

7. The method of claim 1, wherein a sequence for phase compensation is expressed by aₖ exp(−jX),
where, aₖ denotes a complex value of a sequence transmitted in a k-th tone and X denotes an average value of phase values obtained through channel estimation.

8. The method of claim 1, wherein the reception terminal is configured to randomize a phase compensation value applied to transmission of the plurality of feedback signals, when channel estimation accuracy is lower than a predetermined threshold.

9. The method of claim 1, wherein the feedback signal indicates only negative acknowledge (NACK).

10. A transmission terminal for receiving a feedback signal in a wireless communication system, the transmission terminal comprises:
a transceiver; and
a processor,
wherein the processor transmits a reference signal to a plurality of reception terminals and receives a plurality of feedback signals based on the reference signal from the plurality of reception terminals, and
wherein each of the plurality of feedback signals includes a signal, to which different phase compensation applies.

11. The transmission terminal of claim 10, wherein the transmission terminal communicates with at least one of a mobile terminal, a network or an autonomous vehicle other than the device.

12. The transmission terminal of claim 10, wherein the transmission terminal implements at least one advanced driver assistance system (ADAS) function based on a signal for controlling movement of the terminal.

13. The transmission terminal of claim 10, wherein the terminal receives user input and switches a driving mode of a device from an autonomous driving mode to a manual driving mode or from a manual driving mode to an autonomous driving mode.

14. The transmission terminal of claim 10,
wherein the transmission terminal is autonomously driven based on external object information, and
wherein the external object information comprises at least one of information on presence/absence of an object, location information of the object, information on a distance between the transmission terminal and the object or relative speed information of the transmission terminal and the object.
